(19) United States
(12) Patent Application Publication
(10) Pub. No.: US 2026/0011143 A1
(43) Pub. Date: Jan. 8, 2026

(54) SYSTEMS AND METHODS FOR ENHANCEMENT OF OBJECT IDENTIFICATION AND TARGETING

(71) Applicant: Carbon Autonomous Robotic Systems Inc., Seattle, WA (US)

(72) Inventors: Raven Pillmann, Seattle, WA (US); Jonathan Logan Mey, Bellingham, WA (US); Alexander Igorevich Sergeev, Newcastle, WA (US); Zachary David New, Seattle, WA (US); Evan William Brossard, Seattle, WA (US)

(21) Appl. No.: 19/328,924

(22) Filed: Sep. 15, 2025

Related U.S. Application Data
(63) Continuation of application No. 19/248,027, filed on Jun. 24, 2025.
(60) Provisional application No. 63/665,561, filed on Jun. 28, 2024.
(60) Provisional application No. 63/764,249, filed on Feb. 27, 2025.

(51) Int. Cl. G06V 20/10; G06N 20/00; G06T 7/50; G06T 7/62

(52) U.S. Cl. CPC G06V 20/188; G06N 20/00; G06T 7/50; G06T 7/62; G06V 2201/07

(57) ABSTRACT

In some variations, a method for enhancing identification and/or targeting of an object of interest includes providing a sample image of a sample object to a user, receiving an indication from the user identifying the sample object, and generating, via a tuning algorithm, a recommended change to one or more parameters based on the indication from the user, and modifying the one or more parameters based on the recommended change. The one or more parameters may be used by a decision algorithm, where the decision algorithm is configured to instruct an action associated with an object of interest in one or more images, based on (i) a pre-trained machine learning model that characterizes the object of interest in the one or more images, and (ii) the one or more parameters.

### CROSS-REFERENCE TO RELATED APPLICATION(S)

This application is a continuation of U.S. patent application Ser. No. 19/248,027, filed Jun. 24, 2025, which claims the benefit of priority to U.S. Provisional Patent Application No. 63/764,249, filed Feb. 27, 2025, and U.S. Provisional Patent Application No. 63/665,561, filed Jun. 28, 2024, each of which is incorporated by reference herein in its entirety.

### TECHNICAL FIELD

The present technology relates to systems and methods for enhancing identification and/or targeting of an object of interest.

### BACKGROUND

As technology advances, tasks that had previously been performed by humans are increasingly becoming automated. While tasks performed in highly controlled environments, such as factory assembly lines, can be automated by directing a machine to perform the task the same way each time, tasks performed in unpredictable environments, such as driving on city streets or vacuuming a cluttered room, depend on dynamic feedback and adaptation to perform the task. Autonomous systems often struggle to identify and locate objects in unpredictable environments. Improved methods of object detection, location, and targeting would advance automation technology and increase the ability of autonomous systems to react and adapt to unpredictable environments.

### SUMMARY

The subject technology is illustrated, for example, according to various aspects described below, including with reference to FIGS. 1-15B. Various examples of aspects of the subject technology are described as numbered clauses (1, 2, 3, etc.) for convenience. These are provided as examples and do not limit the subject technology.
1. A method comprising:
providing a sample image of a sample object to a user;
receiving an indication from the user identifying the sample object;
generating, via a tuning algorithm, a recommended change to one or more parameters based on the indication from the user, wherein a decision algorithm is configured to instruct an action associated with an object of interest in one or more images using (i) a pre-trained machine learning model that characterizes the object of interest in the one or more images, and (ii) the one or more parameters; and
modifying the one or more parameters based on the recommended change.
2. The method of clause 1, wherein modifying one or more parameters does not comprise retraining the pre-trained machine learning model.
3. The method of clause 1 or 2, wherein the tuning algorithm comprises a rule-based algorithm, a statistical model-based algorithm, or both.
4. The method of any one of clauses 1-3, wherein the tuning algorithm comprises a second pre-trained machine learning model, and wherein the second pre-trained machine learning model is separate from the pre-trained machine learning model configured to characterize the object of interest in an image.
5. The method of any one of clauses 1-4, wherein the tuning algorithm is configured to generate a recommended change to one or more parameters in order to optimize a predetermined metric of interest.
6. The method of any one of clauses 1-5, wherein the pre-trained machine learning model is configured to predict one or more properties of the object of interest in one or more images.
7. The method of clause 6, further comprising storing the one or more predicted properties of the object of interest in an embedding associated with the object of interest.
8. The method of clause 6 or 7, wherein the one or more predicted properties comprises a first object score representing likelihood that the object of interest is a first object type.
9. The method of clause 8, wherein generating a recommended change comprises generating a recommended change to a first threshold value, wherein the decision algorithm is configured to instruct a first action in response to the first object score satisfying the first threshold value.
10. The method of clause 9, wherein the first object type is a crop and the first action comprises instructing an implement to not damage the object of interest.
11. The method of clause 9, wherein the first object type is a crop and the first action comprises instructing an implement to damage the object of interest.
12. The method of any one of clauses 8-11, wherein the one or more predicted properties further comprises a second object score representing likelihood that the object of interest is a second object type.
13. The method of clause 12, wherein generating a recommended change comprises generating a recommended change to a second threshold value, wherein the decision algorithm is configured to instruct a second action in response to the second object score satisfying the second threshold value.
14. The method of clause 13, wherein the second object type is a weed and the second action comprises instructing an implement to damage the object of interest.
15. The method of any one of clauses 6-14, wherein the one or more predicted properties comprises a number of images in which the object of interest is pictured, and wherein generating a recommended change comprises generating a recommended change to a minimum threshold quantity of images in which the object of interest is pictured, for instructing an action associated with the object of interest.
16. The method of any one of clauses 6-15, wherein the one or more predicted properties comprises at least one of size or shape of the object of interest.
17. The method of any one of clauses 1-16, further comprising collecting a plurality of sample images of a plurality of sample objects, wherein the sample objects are representative of objects of interest to be characterized by the pre-trained machine learning model.
18. The method of clause 17, wherein providing a sample image comprises displaying the plurality of sample images on a display.
19. A system, comprising:
a processor; and
a memory operably coupled to the processor and storing instructions that, when executed by the processor, cause the system to:
   provide a sample image of a sample object to a user;
   receive an indication from the user identifying the sample object;
   generate, via a tuning algorithm, a recommended change to one or more parameters based on the indication from the user, wherein a decision algorithm is configured to instruct an action associated with an object of interest in one or more images using (i) a pre-trained machine learning model that characterizes the object of interest in the one or more images, and (ii) the one or more parameters; and
   modify the one or more parameters based on the recommended change.
20. The system of clause 19, wherein when the instructions cause the system to modify the one or more parameters, the modification does not comprise retraining the pre-trained machine learning model.
21. The system of clause 19 or 20, wherein the tuning algorithm comprises a rule-based algorithm, a statistical model-based algorithm, or both.
22. The system of any one of clauses 19-21, wherein the tuning algorithm comprises a second pre-trained machine learning model, and wherein the second pre-trained machine learning model is separate from the pre-trained machine learning model configured to characterize the object of interest in an image.
23. The system of any one of clauses 19-22, wherein the tuning algorithm is configured to generate a recommended change to one or more parameters in order to optimize a predetermined metric of interest.
24. The system of any one of clauses 19-23, wherein the pre-trained machine learning model is configured to predict one or more properties of the object of interest in one or more images.
25. The system of clause 24, wherein the one or more predicted properties of the object of interest is stored in an embedding associated with the object of interest.
26. The system of clause 24 or 25, wherein the one or more predicted properties comprises a first object score representing likelihood that the object of interest is a first object type.
27. The system of clause 26, wherein when the instructions cause the system to generate a recommended change, the system generates a recommended change to a first threshold value, wherein the decision algorithm is configured to instruct a first action in response to the first object score satisfying the first threshold value.
28. The system of clause 27, wherein the first object type is a crop and the first action comprises instructing an implement to not damage the object of interest.
29. The system of clause 27, wherein the first object type is a crop and the first action comprises instructing an implement to damage the object of interest.
30. The system of any one of clauses 26-29, wherein the one or more predicted properties further comprises a second object score representing likelihood that the object of interest is a second object type.
31. The system of clause 30, wherein when the instructions cause the system to generate a recommended change, the system generates a recommended change to a second threshold value, wherein the decision algorithm is configured to instruct a second action in response to the second object score satisfying the second threshold value.
32. The system of clause 31, wherein the second object type is a weed and the second action comprises instructing an implement to damage the object of interest.
33. The system of clause 32, wherein the implement comprises a laser and a control system configured to direct the laser at the object of interest.
34. The system of any one of clauses 24-33, wherein the one or more predicted properties comprises a number of images in which the object of interest is pictured, and wherein generating a recommended change comprises generating a recommended change to a minimum threshold quantity of images in which the object of interest is pictured, for instructing an action associated with the object of interest.
35. The system of any one of clauses 24-34, wherein the one or more predicted properties comprises at least one of size or shape of the object of interest.
36. The system of any one of clauses 19-35, further comprising a camera configured to collect a plurality of sample images of a plurality of sample objects, wherein the sample objects are representative of objects of interest to be characterized by the pre-trained machine learning model.
37. The system of clause 36, further comprising a display configured to display the plurality of sample images.
38. A method comprising:
providing a sample image of a sample plant to a user;
receiving an indication from the user identifying the sample plant as a crop or a weed;
generating, via a tuning algorithm, a recommended change to one or more parameters based on the indication from the user, wherein a decision algorithm is configured to selectively target a plant of interest in one or more images using (i) a pre-trained machine learning model that characterizes the plant of interest in the one or more images, and (ii) the one or more parameters; and
modifying the one or more parameters based on the recommended change.
39. The method of clause 38, wherein modifying one or more parameters does not comprise retraining the pre-trained machine learning model.
40. The method of clause 38 or 39, wherein the tuning algorithm comprises a rule-based algorithm, a statistical model-based algorithm, or both.
41. The method of any one of clauses 38-40, wherein the tuning algorithm comprises a second pre-trained machine learning model, and wherein the second pre-trained machine learning model is separate from the pre-trained machine learning model configured to characterize the plant of interest in an image.
42. The method of any one of clauses 38-41, wherein the tuning algorithm is configured to generate a recommended change to one or more parameters in order to optimize a predetermined metric of interest.
43. The method of clause 42, wherein the predetermined metric of interest comprises at least one of number of weeds in one or more images targeted for damage, number of crops in one or more images targeted for damaging, number of weeds detected in one or more images, or number of crops detected in one or more images.
44. The method of any one of clauses 38-43, wherein the pre-trained machine learning model is configured to predict one or more properties of the plant of interest in one or more images.
45. The method of clause 44, further comprising storing the one or more predicted properties of the plant of interest in an embedding associated with the plant of interest.
46. The method of clause 44 or 45, wherein the one or more predicted properties comprises a crop score representing likelihood that the plant of interest is a crop.
47. The method of clause 46, wherein generating a recommended change comprises generating a recommended change to a crop score threshold, wherein the decision algorithm is configured to perform one of: to instruct an implement to not damage the plant of interest or to instruct an implement to damage the plant of interest, in response to the crop score satisfying the crop score threshold.
48. The method of any one of clauses 45-47, wherein the one or more predicted properties further comprises a weed score representing likelihood that the plant of interest is a weed.
49. The method of clause 48, wherein generating a recommended change comprises generating a recommended change to a weed score threshold, wherein the decision algorithm is configured to instruct an implement to damage the plant of interest, in response to the weed score satisfying the weed score threshold.
50. The method of any one of clauses 45-49, wherein the one or more predicted properties comprises a number of images in which the plant of interest is pictured, and wherein generating a recommended change comprises generating a recommended change to a minimum threshold quantity of images in which the plant of interest is pictured, for instructing an action associated with the plant of interest.
51. The method of any one of clauses 45-50, wherein the one or more predicted properties comprises at least one of size or shape of the plant of interest.
52. The method of any one of clauses 38-51, further comprising collecting a plurality of sample images of a plurality of sample plants, wherein the sample plants are representative of plants of interest to be characterized by the pre-trained machine learning model.
53. The method of clause 52, wherein providing a sample image comprises displaying the plurality of sample images on a display.
54. A system, comprising:
a processor; and
a memory operably coupled to the processor and storing instructions that, when executed by the processor, cause the system to:
   provide a sample image of a sample plant to a user;
   receive an indication from the user identifying the sample plant as a crop or a weed;
   generate, via a tuning algorithm, a recommended change to one or more parameters based on the indication from the user, wherein a decision algorithm is configured to selectively target a plant of interest in one or more images using (i) a pre-trained machine learning model that characterizes the plant of interest in the one or more images, and (ii) the one or more parameters; and
   modify the one or more parameters based on the recommended change.
55. The system of clause 54, wherein when the instructions cause the system to modify the one or more parameters, the modification does not comprise retraining the pre-trained machine learning model.
56. The system of clause 54 or 55, wherein the tuning algorithm comprises a rule-based algorithm, a statistical model-based algorithm, or both.
57. The system of any one of clauses 54-56, wherein the tuning algorithm comprises a second pre-trained machine learning model, and wherein the second pre-trained machine learning model is separate from the pre-trained machine learning model configured to characterize the plant of interest in an image.
58. The system of any one of clauses 54-57, wherein the tuning algorithm is configured to generate a recommended change to one or more parameters in order to optimize a predetermined metric of interest.
59. The system of clause 58, wherein the predetermined metric of interest comprises at least one of number of weeds in one or more images targeted for damage, number of crops in one or more images targeted for damaging, number of weeds detected in one or more images, or number of crops detected in one or more images.
60. The system of any one of clauses 54-59, wherein the pre-trained machine learning model is configured to predict one or more properties of the plant of interest in one or more images.
61. The system of clause 60, wherein the one or more predicted properties of the plant of interest is stored in an embedding associated with the plant of interest.
62. The system of clause 60 or 61, wherein the one or more predicted properties comprises a crop score representing likelihood that the plant of interest is a crop.
63. The system of clause 62, wherein when the instructions cause the system to generate a recommended change, the system generates a recommended change to a crop score threshold, wherein the decision algorithm is configured to perform one of: to instruct an implement to not damage the plant of interest or to instruct an implement to damage the plant of interest, in response to the crop score satisfying the crop score threshold.
64. The system of clauses 60-63, wherein the one or more predicted properties further comprises a weed score representing likelihood that the plant of interest is a weed.
65. The system of clause 64, wherein when the instructions cause the system to generate a recommended change, the system generates a recommended change to a weed score threshold, wherein the decision algorithm is configured to instruct an implement to damage the plant of interest, in response to the weed score satisfying the weed score threshold.
66. The system of clause 65, wherein the implement comprises a laser and a control system configured to direct the laser at the plant of interest.
67. The system of any one of clauses 60-66, wherein the one or more predicted properties comprises a number of images in which the plant of interest is pictured, and wherein generating a recommended change comprises generating a recommended change to a minimum threshold quantity of images in which the plant of interest is pictured, for instructing an action associated with the plant of interest.
68. The system of any one of clauses 60-67, wherein the one or more predicted properties comprises at least one of size or shape of the plant of interest.
69. The system of any one of clauses 54-68, further comprising a camera configured to collect a plurality of sample images of a plurality of sample plants, wherein the sample plants are representative of plants of interest to be characterized by the pre-trained machine learning model.
70. The system of clause 69, further comprising a display configured to display the plurality of sample images.
71. A method comprising:
providing a sample image of a sample object to a user;
receiving an indication from the user identifying the sample object as a user-created object type;
generating a sample embedding describing the sample object by analyzing the sample image with a pre-trained machine learning model;
associating the indication and the sample embedding with the sample object;
defining a support set of images including the sample image, wherein the support set comprises one or more images of sample objects across a dynamic set of one or more object types including the user-created object type;
receiving a candidate image of an object of interest;
generating a candidate embedding describing the object of interest by analyzing the candidate image with the pre-trained machine learning model;
identifying the object of interest based at least in part by comparing the candidate embedding to one or more sample embeddings associated with the one or more sample objects in the images of the support set.
72. The method of clause 71, wherein the pre-trained machine learning model is not re-trained between generating the sample embedding and generating the candidate embedding.
73. The method of clause 71 or 72, wherein the sample embedding comprises one or more predicted properties of the sample object, and wherein the candidate embedding comprises one or more predicted properties of the object of interest.
74. The method of clause 73, wherein the one or more predicted properties of the object of interest comprises at least one of size or shape of the object of interest.
75. The method of clause 73 or 74, wherein the one or more predicted properties of the candidate embedding comprises a first object score representing likelihood that the object of interest is a first object type.
76. The method of clause 75, wherein the first object type is a crop and the method further comprises instructing an implement to not damage the object of interest.
77. The method of clause 75, wherein the first object type is a crop and the method further comprises instructing an implement to damage the object of interest.
78. The method of any one of clauses 73-77, wherein the one or more predicted properties of the candidate embedding further comprises a second object score representing likelihood that the object of interest is a second object type.
79. The method of clause 78, wherein the second object type is a weed and the method further comprises instructing an implement to damage the object of interest.
80. The method of any one of clauses 71-79, wherein comparing the candidate embedding to one or more sample embeddings comprises inputting the candidate embedding and one or more sample embeddings into a distance-based classification algorithm.
81. The method of clause 80, wherein the distance-based classification algorithm comprises one or more of: a K-nearest neighbors algorithm, a decision tree algorithm, a random forest algorithm, or a neural network.
82. The method of any one of clauses 71-81, wherein comparing the candidate embedding to one or more sample embeddings comprises utilizing one or more of: a support vector machine (SVM) algorithm, a classification algorithm, or regression algorithm.
83. The method of any one of clauses 71-82, further comprising collecting the sample image.
84. The method of any one of clauses 71-83, wherein providing a sample image comprises displaying the sample image on a display.
85. The method of any one of clauses 71-84, where the sample object and the object of interest are plants.
86. A system, comprising:
a processor; and
a memory operably coupled to the processor and storing instructions that, when executed by the processor, cause the system to:
   provide a sample image of a sample object to a user;
   receive an indication from the user identifying the sample object as a user-created object type;
   generate a sample embedding describing the sample object by analyzing the sample image with a pre-trained machine learning model;
   associate the indication and the sample embedding with the sample object;
   define a support set of images including the sample image, wherein the support set comprises one or more images of sample objects across a dynamic set of one or more object types including the user-created object type;
   receive a candidate image of an object of interest;
   generate a candidate embedding describing the object of interest by analyzing the candidate image with the pre-trained machine learning model;
   identify the object of interest based at least in part by comparing the candidate embedding to one or more sample embeddings associated with the one or more sample objects in the images of the support set.
87. The system of clause 86, wherein the pre-trained machine learning model is not re-trained between generating the sample embedding and generating the candidate embedding.
88. The system of clause 86 or 87, wherein the sample embedding comprises one or more predicted properties of the sample object, and wherein the candidate embedding comprises one or more predicted properties of the object of interest.
89. The system of clause 88, wherein the one or more predicted properties of the object of interest comprises at least one of size or shape of the object of interest.
90. The system of clause 88 or 89, wherein the one or more predicted properties of the candidate embedding comprises a first object score representing likelihood that the object of interest is a first object type.
91. The system of clause 90, wherein the first object type is a crop and the method further comprises instructing an implement to not damage the object of interest.
92. The system of clause 90, wherein the first object type is a crop and the method further comprises instructing an implement to damage the object of interest.
93. The system of any one of clauses 88-92, wherein the one or more predicted properties of the candidate embedding further comprises a second object score representing likelihood that the object of interest is a second object type.
94. The system of clause 93, wherein the second object type is a weed and the method further comprises instructing an implement to damage the object of interest.
95. The system of clause 94, wherein the implement comprises a laser and a control system configured to direct the laser at the plant of interest.
96. The system of any one of clauses 86-95, wherein comparing the candidate embedding to one or more sample embeddings comprises inputting the candidate embedding and one or more sample embeddings into a distance-based classification algorithm.
97. The system of clause 96, wherein the distance-based classification algorithm comprises one or more of: a K-nearest neighbors algorithm, a decision tree algorithm, a random forest algorithm, or a neural network.
98. The system of any one of clauses 86-97, wherein comparing the candidate embedding to one or more sample embeddings comprises utilizing one or more of: a support vector machine (SVM) algorithm, a classification algorithm, or regression algorithm.
99. The system of any one of clauses 86-98, further comprising a camera configured to collect the sample image.
100. The system of any one of clauses 86-99, further comprising a display configured to display the sample image.
101. The system of any one of clauses 86-100, where the sample object and the object of interest are plants.

### BRIEF DESCRIPTION OF THE DRAWINGS

Many aspects of the present disclosure can be better understood with reference to the following drawings. The components in the drawings are not necessarily to scale. Instead, emphasis is placed on illustrating clearly the principles of the present disclosure.

FIG. 1 is a schematic illustration of an example autonomous plant targeting system, in accordance with the present technology.

FIG. 2 is a schematic illustration of an example autonomous plant targeting system navigating a field of crops while implementing various techniques in accordance with the present technology.

FIG. 3 is a schematic illustration of an example detection system positioned on an autonomous plant targeting system, in accordance with the present technology.

FIG. 4 is a block diagram illustrating components of an example prediction system, an example targeting system, and an example tuning system in accordance with the present technology.

FIG. 5 is a block diagram illustrating components of a tuning system in accordance with the present technology.

FIG. 6 is an illustrative flow chart illustrating aspects of an example method for enhancing object identification and targeting, in accordance with the present technology.

FIG. 7 is an example user interface relating to enhancement of a plant detection algorithm, in accordance with the present technology.

FIGS. 8A and 8B are example user interfaces relating to a tuning algorithm for enhancing a plant detection algorithm, in accordance with the present technology.

FIG. 9 is an illustrative flowchart illustrating aspects of an example method for enhancing object identification and targeting, in accordance with the present technology.

FIG. 10 is an illustrative flowchart illustrating aspects of an example method for enhancing object identification and targeting, in accordance with the present technology.

FIG. 11 is an illustrative flowchart illustrating aspects of an example method for identifying an object using a pre-trained identification machine learning model, in accordance with the present technology.

FIGS. 12A-12C depict application of n K-nearest neighbors algorithm as a pre-trained identification machine learning algorithm, in accordance with the present technology.

FIGS. 13A-13D are example graphical user interfaces (GUIs) for enhancing object identification and targeting, in accordance with the present technology.

FIG. 14A is an illustrative flowchart illustrating aspects of an example method for training an identification machine learning model. FIGS. 14B and 14C illustrate example images for use in the method of FIG. 14A.

FIG. 15A is an illustrative flowchart illustrating aspects of an example method for training an identification machine learning model. FIG. 15B illustrates example images for use in the method of FIG. 15A.

### DETAILED DESCRIPTION

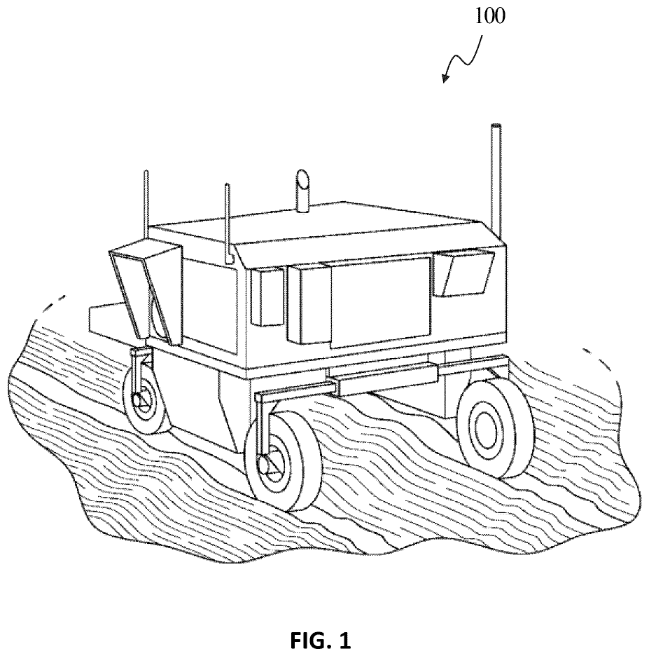

The present technology relates to systems and methods for enhancement of object identification and targeting. Some variations of the present technology, for example, are directed to the enhancement of plant identification and targeting. Specific details of several variations of the technology are described below with reference to FIGS. 1-15B.

Object detection algorithms may incorporate one or more machine learning models to analyze images depicting objects of interest. Such analysis can generate information regarding a pictured object of interest, and an autonomous system may, in many instances, generate a conclusion by comparing that information to one or more parameters. For example, an algorithm may determine one or more quantitative properties of an object of interest, and those one or more quantitative properties can be assessed relative to certain parameters to generate a conclusion regarding the object of interest (e.g., whether to perform an action in relation to the object of interest). Conventional methods of adjusting object detection algorithms can involve complex adjustments that may require several iterations to optimize the object detection algorithm in a guess-and-check process, and because each iteration requires in-field testing and subsequent analysis of that iteration for areas of improvement (as well as potentially retraining the machine learning model(s)), the process of adjusting an object detection algorithm can be time-consuming. Thus, optimizing or adjusting object detection algorithms for different scenarios (e.g., different objects of interest, different use environments, different hardware that collects images of the objects of interest, etc.) can be very time-consuming and result in dissatisfaction in the performance of the object detection algorithm.

Thus, the present technology relates to systems and methods for enhancing object detection by enabling adjustment of parameter(s) using input from a user who may be less remote from the use environment in which an object detection system (e.g., autonomous object detection system) is operated. For example, such systems and methods enable adjustment of parameter(s) used by a decision algorithm, where the decision algorithm is an algorithm that is separate from a pre-trained machine learning model for analyzing images of objects of interest. Specifically, in some variations the decision algorithm may be configured to generate a conclusion (e.g., instruct an action) associated with an object of interest based on output of the pre-trained machine learning model and one or more parameters. Changes to such one or more parameter(s) may be recommended based on an automated analysis of user input regarding sample images (e.g., user labels of sample objects in the sample images), to improve or otherwise enhance the object detection for other objects of interest, without requiring modifying (e.g., retraining) of the pre-trained machine learning model. These changes can be generated and implemented nearly immediately during in-field use of the object detection system, if desired. Accordingly, the systems and methods in accordance with the present technology can enhance the performance of object detection (e.g., identification, targeting, etc.) with faster and potentially more accurate results, compared to conventional methods for adjusting object detection algorithms.

In some variations, the methods of the present technology may be implemented by an autonomous plant targeting system to target and eliminate an object of interest, such as a plant of interest (e.g., weed). For example, an autonomous plant targeting system may include a detection system configured to detect and locate a plant of interest identified in images or representations collected by a first sensor, such as a prediction sensor, over time relative to the autonomous plant targeting system. The detection information may be used to determine a predicted location of the plant of interest relative to the system. The autonomous plant targeting system may then locate the same plant in an image or representation collected by a second sensor, such as a targeting sensor, using the predicted location. In some variations, the first sensor is a prediction camera, and the second sensor is a targeting camera. One or both of the first sensor and the second sensor may be moving relative to the plant of interest. For example, the prediction camera may be coupled to and moving with the autonomous plant targeting system.

Targeting the plant of interest may comprise precisely locating the plant using the targeting sensor, targeting the plant with a laser, and eradicating the plant by burning it with laser light, such as infrared light. For example, in some variations the plant of interest may be a weed, as distinct from a crop that is desired to be maintained alive. As another example, in some variations the plant of interest may be any other suitable unwanted plant (e.g., failing crop, such as a small crop plant, a diseased crop plant, a crop plant located in an undesirable location, etc.). The prediction sensor may be part of a prediction system configured to determine a predicted location of an object of interest (e.g., plant of interest), and the targeting sensor may be part of a targeting system configured to refine the predicted location of the object of interest to determine a target location and target the object of interest with the laser at the target location. The prediction system may be configured to communicate with the targeting system to coordinate a camera handoff using point to point targeting, such as that described in U.S. Patent Publication No. 2022/0299635, which is incorporated herein by reference. The targeting system may target the object at the predicted location. In some variations, the targeting system may use the trajectory of the object to dynamically target the object while the system is in motion such that the position of the targeting sensor, the laser, or both is adjusted to maintain the target.

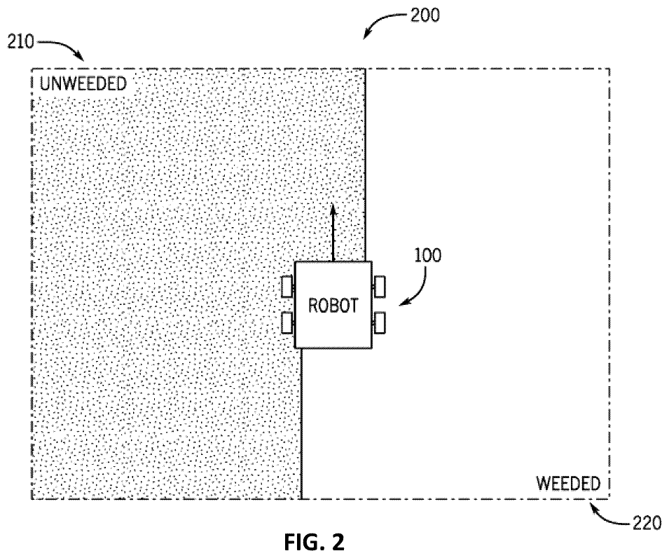

An autonomous plant targeting system may identify, target, and eliminate certain plants without human input. In some variations, the autonomous plant targeting system may be positioned on a self-driving vehicle or a piloted vehicle or may be pulled by a vehicle such as a tractor. For example, as shown in FIG. 1, an autonomous plant targeting system may be part of or coupled to a vehicle 100, such as a tractor or self-driving vehicle. The autonomous plant targeting system may, for example, be configured to target weeds, though can additionally or alternatively be configured to target any other undesired objects (e.g., undesired plants, pests, etc.). In some variations, the vehicle 100 may drive through a field of crops 200, as illustrated in FIG. 2. As the vehicle 100 drives through the field 200 it may identify, target, and eradicate weeds in an unweeded section 210 of the field, leaving a weeded field 220 behind it. The methods in accordance with the present technology may be implemented by the autonomous plant targeting system to identify, target, and eradicate certain objects of interest while the vehicle 100 is in motion. The high precision of such methods enables accurate targeting of objects of interest, such as with a laser, to eradicate the object of interest without damaging nearby objects. The high precision of such methods enables accurate targeting of plants, such as with a laser, to eradicate the plants without damaging nearby crops. U.S. Pat. No. 11,602,143, which is incorporated by reference, describes autonomous targeting systems that may be used to perform at least some portion of the methods in accordance with the present technology.

While the primary focus of the methods described herein is on the identification, selection, and targeting of plants, the applicability of the underlying technology is not limited to plant detection. The system's advanced imaging and predictive analytics capabilities can be designed to identify and locate objects in unpredictable environments, which inherently allows for the detection of a wide range of objects beyond just plants. The methods and systems described are capable of detecting any distinguishable items or areas that can be observed within their operational field. This includes, but is not limited to, debris, infrastructure elements, people, animals, or other items that may be present in an agricultural setting or other suitable setting (e.g., home). The flexibility and adaptability of the system's object detection technology enable it to be applied to various scenarios where autonomous detection and manipulation of objects are beneficial. Therefore, while the application predominantly illustrates the system's utility in an agricultural context, the principles and mechanisms of object detection and targeting it employs can be generalized to other applications where identifying and interacting with various objects is desired.

### I. Object Detection System

In some variations, the methods in accordance with the present technology may be performed by a detection system configured to identify and target an object of interest. In some variations, the detection system may be positioned on or coupled to a vehicle, such as a self-driving plant targeting vehicle or a plant targeting trailer pulled by a tractor. The detection system may include a prediction system, a targeting system, and a tuning system configured to enhance the accuracy of the prediction system and/or the targeting system.

Generally, as further described herein, the prediction system may be configured to identify object(s) of interest in one or more images and/or track the location of such objects relative to a moving body, such as by using the methods described herein. For example, in some variations, the prediction system may be configured to capture an image or representation of a region of a surface using a prediction camera and/or other prediction sensor, identify an object of interest in the image, and/or determine a predicted location of the object. Accordingly, the prediction system may be configured to process image data to generate a virtual representation of the region, identifying the location (that is, current and/or future locations relative to the moving body as the moving body moves) and parameters of individual objects, such as crops, within that space.

Once an object has been identified and its location predicted, the prediction system communicates this information to the targeting system. The targeting system can apply a decision algorithm to decide whether to perform an action associated with the object. For example, the decision algorithm can generate an instruction for the targeting system to aim an implement, such as a laser, at the object (e.g., to destroy or damage the object). The targeting system may ensure that the implement is accurately directed towards the object's current or future location, accounting for any movement of the object or the autonomous system itself. The prediction system's ability to forecast the object's location allows the targeting module to compensate for any delays between the identification of the object and the moment of action, ensuring that the targeting is precise and effective. This coordination is particularly useful when the autonomous system is in motion, as it allows for dynamic adjustments to be made in real-time, ensuring that the targeting remains accurate despite any changes in the relative positions of the system and the objects.

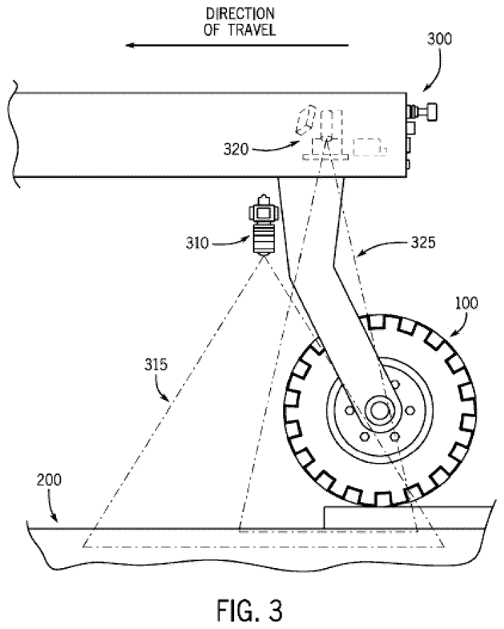

An example of a detection system 300 is shown in the illustrative schematic of FIG. 3. The detection system may be part of or coupled to a vehicle 100, such as a self-driving plant targeting vehicle or a laser plant targeting system trailer pulled by a tractor, that moves along a surface, such as a crop field 200. The detection system 300 includes a prediction system 310, including a prediction sensor with a prediction field of view 315, and a targeting system 320, including a targeting sensor with a targeting field of view 325. The targeting system may further include an implement, such as a laser, with a target area that overlaps with the targeting field of view 325. In some variations, the prediction system 310 is positioned ahead of the targeting system 320, along the direction of travel of the vehicle 100, such that the targeting field of view 325 overlaps with the prediction field of view 315 with a temporal delay. For example, the prediction field of view 315 at a first time may overlap with the targeting field of view 325 at a second time. In some variations, the prediction field of view 315 at the first time may not overlap with the targeting field of view 325 at the first time.

In other example variations, the system does not require the prediction system to be physically located in front of the targeting system. The primary objective is to ensure that the prediction system's field of view precedes the targeting system's field of view in the direction of the system's movement, allowing for the timely prediction and subsequent targeting of objects. As a nonlimiting example, in other example embodiments the prediction sensor may be angled in such a way that its field of view extends further ahead in the travel path, even if the sensor itself is not positioned at the frontmost point of the system. This flexibility in sensor arrangement is particularly advantageous in scenarios where space constraints or design considerations necessitate a more compact or non-linear configuration of system components.

The detection system of the present technology may be used to target objects on a surface, such as the ground, a dirt surface, a floor, a wall, an agricultural surface (e.g., a field), a lawn, a road, a mound, a pile, or a pit. In some variations, the surface may be a non-planar surface, such as uneven ground, uneven terrain, or a textured floor. For example, the surface may be uneven ground at a construction site, in an agricultural field, or in a mining tunnel, or the surface may be uneven terrain containing fields, roads, forests, hills, mountains, houses, or buildings. The detection systems in accordance with the present technology may locate an object on a non-planar surface more accurately, faster, or within a larger area than a single sensor system or a system lacking an object matching module.

Additionally or alternatively, the detection system may be used to target objects that may be spaced from the surface they are resting on, such as a tree top distanced from its grounding point, and/or to target objects that may be locatable relative to a surface, for example, relative to a ground surface in air or in the atmosphere. In addition, the detection system may be used to target objects that may be moving relative to a surface, for example, a vehicle, an animal, a human, or a flying object.

The prediction system and the targeting system may be used in combination to locate, identify, and target an object with an implement. The prediction system and the targeting system may be in communication, for example electrical or digital communication. The targeting system may comprise an optical control system as described in further detail below. In some variations, the prediction system and the targeting system are directly or indirectly coupled. For example, the prediction system and the targeting system may be coupled to a support structure. In some variations, the prediction system and the targeting system are configured on or coupled to a vehicle, such as the vehicle shown in FIG. 1 and FIG. 2. For example, the prediction system and the targeting system may be positioned on a self-driving vehicle. In another example, the prediction system and the targeting system may be positioned on a trailer pulled by another vehicle, such as a tractor.

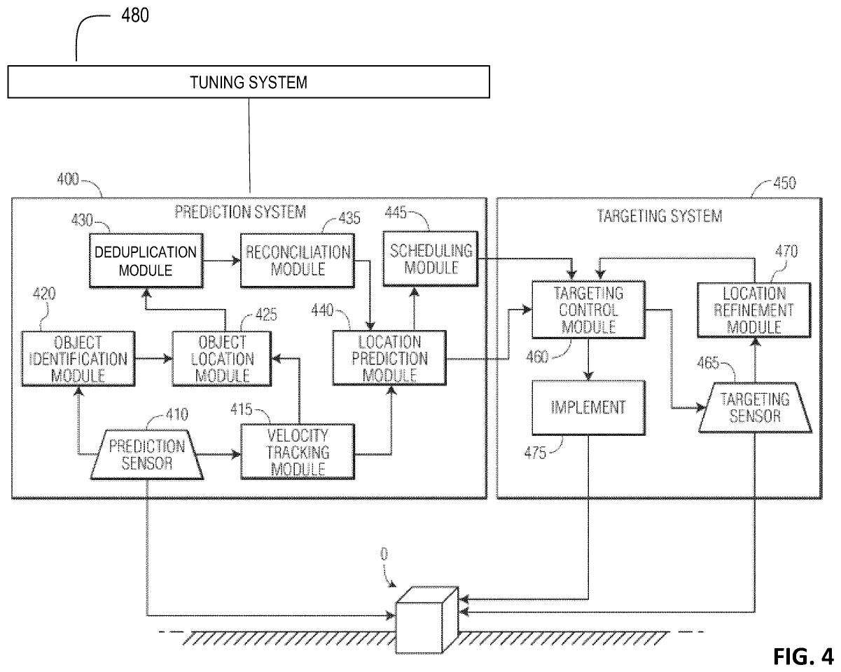

FIG. 4 is a schematic illustration of a detection system comprising a prediction system 400 and a targeting system 450 for tracking at targeting an object O relative to a moving body, such as vehicle 100 illustrated in FIG. 1-FIG. 3. The prediction system 400, the targeting system 450, or both may be positioned on or coupled to the moving body (e.g., the moving vehicle). The prediction system 400 and the targeting system 450 are described in further detail below. Furthermore, U.S. Pat. No. 11,602,143 (which is incorporated herein in its entirety by this reference) describes additional details regarding an example autonomous plant targeting system with which the detection system of the present technology can be used.

### A. Prediction System

As described above, the prediction system in accordance with the present technology may be configured to identify object of interest in one or more images and/or track the location of such objects in their trajectories relative to a moving body. In some variations, a prediction system is configured to capture an image or representation of a region of a surface using a prediction camera and/or other prediction sensor, identify an object of interest in the image, and/or determine a predicted location of the object. The prediction system may include a system controller, for example a system computer having storage, random access memory (RAM), a central processing unit (CPU), and a graphics processing unit (GPU). The system computer may comprise a tensor processing unit (TPU). The system computer may comprise sufficient RAM, storage space, CPU power, and GPU power to perform operations to detect and identify a target.

In some variations, the prediction system may include a prediction sensor configured to generate an image for analysis by the prediction system. For example, as shown in FIG. 4, the prediction system 400 may include a prediction sensor 410 configured to image a region, such as a region of a surface, containing one or more objects, including object O. In some variations, the prediction system may include a plurality of prediction sensors, enabling coverage of a larger region of interest. The prediction sensor may provide images of sufficient resolution on which to perform operations to detect and identify an object. In some variations, the prediction sensor may be a camera, such as a charge-coupled device (CCD) camera or a complementary metal-oxide-semiconductor (CMOS) camera, a LIDAR detector, an infrared sensor, an ultraviolet sensor, an x-ray detector, or any other sensor capable of generating an image.

The prediction system may further include an object identification module configured to identify an object of interest and differentiate the object of interest from other objects in the prediction image collected by the prediction sensor. For example, as shown in FIG. 4 the prediction system 400 may include an object identification module 420 configured to identify objects and their properties in image(s) collected by the prediction sensor. In some variations, the object identification module uses at least one pre-trained identification machine learning model to identify and differentiate objects, such as by predicting one or more properties of objects in the images. In some variations, visual characteristics of the object may be represented by a numerical representation in the form of an embedding (e.g., feature vector), such that similar-looking objects may have similar embeddings and different-looking objects have dissimilar embeddings. For example, the identification machine learning model may be trained to identify plants and differentiate plants of interest from other plants, such as crops. The identification machine learning model may predict plant properties for the object, such as a weed score (e.g., confidence score representing likelihood that the object is a weed), a crop score (e.g., confidence score representing likelihood that the object is a crop), a quantification (e.g., number) of images in which the object is pictured, and/or visual characteristics of the plant (e.g., direct or indirect representations or other characterizations of size, shape, health, etc.). Using these properties, the prediction system may be configured to identify a plant and to differentiate between different plants, such as between a crop and a weed.

The identification machine learning model may be trained with many training images, such as high-resolution images, for example of surfaces with or without objects of interest. For example, the machine learning model may be trained with images of fields with or without weeds. The training of the identification machine learning model can be based on properties (e.g., features) extracted from a training dataset comprising labeled images of objects. The training process involves feeding the model numerous examples of images that contain the objects of interest, along with annotations that describe what the objects are and where they are located within the images. The model is trained to differentiate between these objects. For example, in some variations the model is trained to identify which plants in image(s) are crops that ought to be preserved and which are weeds or excess crops that can be targeted for removal. Once trained, the object identification module 420 can process new images from the prediction sensor and apply the learned patterns to identify objects in real-time. It can differentiate objects of interest from the background and other objects that are not relevant to the task at hand. The object identification module may use various machine learning techniques, such as convolutional neural networks (CNNs), though the identification machine learning model may include any suitable types of machine learning model(s).

Once trained, the machine learning model may be configured to identify a region in the image containing an object of interest. The region may be defined by a polygon, for example a rectangle. In some embodiments, the region is a bounding box. In some variations, the region is a polygon mask covering an identified region. In some variations, the identification machine learning model may be trained to determine a location of the object of interest, for example a pixel location within a prediction image.

In some variations, the prediction system may further include an object location module configured to determine locations of objects identified by the object identification module. For example, as shown in FIG. 4, the prediction system 400 may include an object location module 425. The object location module 425 may determine locations of the objects identified by the object identification module 420 and to compile a set of identified objects and their corresponding locations. Object identification and object location may be performed on a series of images collected by the prediction sensor 410 over time. The set of identified objects and corresponding locations from in two or more images from the object location module 425 may be sent to a deduplication module, such as deduplication module 430.

The deduplication module (e.g., deduplication module 430) may use object locations in a first image collected at a first time and object locations in a second image collected at a second time to identify objects, such as object O, appearing in both the first image and the second image. The set of identified objects and corresponding locations may be deduplicated by the deduplication module by assigning locations of an object appearing in both the first image and the second image to the same object O. In some variations, the deduplication module may use a velocity estimate from the velocity tracking module (e.g., velocity tracking module 415), described below, to identify corresponding objects appearing in both images. The resulting deduplicated set of identified objects may contain unique objects, each of which has one or more corresponding locations determined at one or more time points.

Machine learning can be applied to this process by using models that recognize and match features of objects across different images. For instance, a machine learning model could be trained on a dataset of sequential images where objects of interest move or change appearance slightly. The model would learn to associate different instances of the same object across these images, despite variations in perspective, lighting, or partial occlusions. Such a model could use techniques like feature matching and object tracking algorithms that are robust to changes in the object's environment. By learning the typical motion patterns or changes in appearance of objects within the field, the trained deduplication module can more accurately determine when different images feature the same object, thereby reducing the likelihood of counting an object more than once.

Furthermore, in some variations the prediction system may include a reconciliation module, which maintains an accurate and current list of objects being tracked. For example, the reconciliation module may remove objects that are no longer relevant, such as those that have not been detected for a set period or number of frames. Machine learning can assist in this process by predicting which objects are likely to reappear based on their last known trajectory and the typical behavior of objects within the environment. A predictive machine learning model could analyze the movement patterns of objects and predict their future positions. If an object temporarily disappears from view (e.g., due to occlusion or moving out of the frame) the model could estimate the likelihood of its return. This would allow the reconciliation module to make informed decisions about whether to keep tracking an object or remove it from the list, optimizing the system's resources and attention. The reconciliation module may provide the reconciled set of objects to the location prediction module, described in further detail below.

For example, as shown in FIG. 4, the prediction system 400 can include a reconciliation module 435. The reconciliation module 435 may receive the deduplicated set of objects from the deduplication module 430 and may reconcile the deduplicated set by removing objects. In some variations, objects may be removed if they are no longer being tracked. For example, an object may be removed if it has not been identified in a predetermined number of images in the series of images. In another example, an object may be removed if it has not been identified in a predetermined period of time. In some variations, objects no longer appearing in images collected by the prediction sensor may continue to be tracked. For example, an object may continue to be tracked if it is expected to be within the prediction field of view based on the predicted location of the object. In another example, an object may continue to be tracked if it is expected to be within range of a targeting system based on the predicted location of the object.

In some variations, the prediction module may comprise a velocity tracking module to determine a velocity of a vehicle to which the prediction system is coupled. For example, as shown in FIG. 4, the prediction system 400 may include a velocity tracking module 415. The velocity tracking module may estimate a velocity of the moving body relative to the region being imaged (e.g., surface). In some variations, the velocity tracking module 415 may comprise a device to measure the displacement of the moving body over time. For example, the velocity tracking module may include a positioning system, such as a wheel encoder or rotary encoder, an Inertial Measurement Unit (IMU), a Global Positioning System (GPS), a ranging sensor (e.g., laser, SONAR, or RADAR), or an Internal Navigation System (INS). For example, a wheel encoder in communication with a wheel of the vehicle may estimate a velocity or a distance traveled based on angular frequency, rotational frequency, rotation angle, or number of wheel rotations. In some variations, the positioning system may be positioned on the vehicle. Additionally or alternatively, the positioning system may be positioned on a vehicle that is spatially coupled to the detection system. For example, the positioning system may be located on a vehicle pulling the detection system. Furthermore, in some variations, the velocity tracking module may additionally or alternatively utilize images from the prediction sensor to determine the velocity of the vehicle using optical flow.

In some variations, the detection system can include a location prediction module configured to determine a predicted location at a future time(s) of object O from the reconciled set of objects (e.g., a trajectory of the object O). For example, as shown in FIG. 4, the prediction system 400 can include a location prediction module 440. In some variations, the predicted location may be determined from two or more corresponding locations determined from images collected at two or more time points or from a single location combined with velocity information from the velocity tracking module. The predicted location of object O may be based on a vector velocity, including speed and direction, of object O relative to the moving body between the location of object O in a first image collected at a first time and the location of object O in a second image collected at a second time. Optionally, the vector velocity may account for a distance of the object O from the moving body along the imaging axis (e.g., a height or elevation of the object relative to the surface). Additionally or alternatively, the predicted location of the object may be based on the location of object O in the first image or in the second image and a vector velocity of the vehicle determined by the from the velocity tracking module.

In some variations, the prediction system may include a scheduling module configured to select objects identified by the prediction module and schedule which objects to target with the targeting system. For example, as shown in FIG. 4, the prediction system 400 may include a scheduling module 445. The scheduling module may schedule objects for targeting based on parameters such as object location, relative velocity, implement activation time, object score (e.g., confidence score representing likelihood that the object is a particular object type), or combinations thereof. For example, the scheduling module 5 may prioritize targeting objects predicted to move out of a field of view of a prediction sensor or a targeting sensor or out of range of an implement. In some variations, the scheduling module may prioritize objects and orchestrate the targeting sequence to efficiently transition between multiple targets. Additionally or alternatively, the scheduling module may prioritize targeting objects identified or located with high confidence. Additionally or alternatively, a scheduling module may prioritize targeting objects with short activation times. In some variations, the scheduling module may prioritize targeting objects based on a user's preferred parameters.

In some variations, the scheduling module (e.g., scheduling module 445) may use a decision algorithm that is configured to instruct or recommend an action associated with an object of interest in one or more images. The decision algorithm may, for example, include a rule-based algorithm and/or at least one machine learning model utilizing information from other modules of the prediction system to generate an instructed or recommended action to perform on the object of interest in the one or more collected images. The decision algorithm may, for example, determine an action to perform on a detected object based on the object's properties (e.g., as predicted by the object identification module using an identification machine learning model) and one or more algorithmic parameters. For example, to determine a suitable action, the decision algorithm may utilize one or more thresholds (e.g., a threshold value against which the weed score is compared, a threshold value against which the crop score is compared, a minimum threshold quantity of images in which the plant should be pictured to permit performance of an action associated with the plant) and/or other assessment of the visual characteristics (e.g., health) of the plant. In some variations, as further described herein, the detection system in accordance with the present technology can include a tuning system configured to tune such one or more algorithmic parameters that are used by the decision algorithm to determine an action.

### B. Targeting System

The detection system may include a targeting system configured to decide whether to perform an action associated with an object. For example, based on an instruction from the prediction system, the targeting system of the present technology may be configured to target an object tracked by a prediction system. The targeting system may ensure that the implement is accurately directed towards the object's current or future location, accounting for any movement of the object or the autonomous system itself. FIG. 4 is a schematic illustration of a detection system with a targeting system 450, which is described in further detail herein.

The targeting system may include a system controller, for example a system computer having storage, random access memory (RAM), a central processing unit (CPU), and a graphics processing unit (GPU). The system computer may comprise a tensor processing unit (TPU). The system computer may comprise sufficient RAM, storage space, CPU power, and GPU power to perform operations to detect and identify a target.

The targeting system may include a targeting sensor configured to image a portion of the region of interest. For example, as shown in FIG. 4, the targeting system 450 may include a targeting sensor 475. In some variations, the targeting system may include a plurality of targeting sensors. The targeting system may be configured to receive a predicted location of an object of interest from the prediction system and point the targeting sensor toward the predicted location. In other words, the targeting system may direct the targeting sensor toward a desired portion of the region of interest predicted to contain the object, based on the predicted location received from the prediction system. The targeting sensor may provide images of sufficient resolution on which to perform operations to target an object (e.g., to match an object to an object identified in a prediction image). In some variations, the targeting sensor may be a camera, such as a charge-coupled device (CCD) camera or a complementary metal-oxide-semiconductor (CMOS) camera, a LIDAR detector, an infrared sensor, an ultraviolet sensor, an x-ray detector, or any other sensor capable of generating an image. In some variations, the targeting sensor may have a smaller field of view than the prediction sensor.

The region of interest may correspond to a region of overlap between the targeting sensor field of view and the prediction sensor field of view. Such overlap may be contemporaneous or may be temporally separated. For example, the prediction sensor field of view can encompass the region of interest at a first time and the targeting sensor field of view can encompass the region of interest at a second time but not at the first time. In some variations, the detection system may move relative to the region of interest between the first time and the second time, facilitating temporally separated overlap of the prediction sensor field of view and the targeting sensor field of view.

In some variations, the targeting module may direct an implement (e.g., implement 475 shown in FIG. 4) toward the object. In some embodiments, the implement may perform an action on or manipulate the object. In some embodiments, the targeting module may use the trajectory of the object to dynamically target the object while the system is in motion such that the position of the targeting sensor, the implement, or both is adjusted to maintain the target. U.S. Patent Publication No. 2022/0299635, which is incorporated herein in its entirety by this reference, describes machine learning models for automated identification, maintenance, control, or targeting of objects that may be used with the methods of the present technology. The position of the targeting sensor and the position of the implement may be coupled. In some variations, a plurality of targeting systems may be in communication with the prediction system.

The implement may be or include one or more suitable devices for acting upon or otherwise manipulating an object. The manipulation of the object by the implement may eradicate the object. For example, the targeting system may be configured to direct a laser beam (e.g., infrared laser light beam) toward a plant to damage (e.g., burn) the plant. In another example, the targeting system may be configured to direct a grabbing tool to grab the object. In another example, the targeting system may direct a spraying tool to spray fluid (e.g., herbicide, pest repellent, etc.) at the object. In some variations, the object may be a weed, a plant, an insect, a pest, a field, a piece of debris, an obstruction, a region of a surface, or any other object that may be manipulated.

The targeting system may include a targeting control module. For example, as shown in FIG. 4, the targeting system 450 may include a targeting control module 460. In some variations, the targeting control module may control the targeting sensor, the implement, or both. In some variations, the targeting control module may include an optical control system comprising optical components configured to control an optical path (e.g., a laser beam path or a camera imaging path). The targeting control module may include software-driven electrical components capable of controlling activation and deactivation of the implement. Activation or deactivation may depend on the presence or absence of an object as detected by the targeting sensor. Activation or deactivation may depend at least in part on the position of the implement relative to the target object location. In some variations, the targeting control module may activate the implement, such as a laser emitter, when an object is identified and located by the prediction system. In some variations, the targeting control module may activate the implement when the range or target area of the implement is positioned to overlap with the target object location.

The targeting system may receive the predicted location of the object at a future time from the prediction system and may use the predicted location to precisely target the object with an implement at the future time. For example, with reference to FIG. 4, the targeting control module 450 may receive the predicted location of object O from the location prediction module 440 of the prediction system 400, and may instruct the targeting sensor 465, the implement 475, or both to point toward the predicted location of the object.

In some variations, the targeting system may further include a location refinement module configured to refine the predicted location of an object provided by the prediction system. For example, as shown in FIG. 4, the targeting system 450 may include a location refinement module 470 configured to refine the predicted location of object O based on the location of object O determined from an image collected by the targeting sensor. In some variations, the location refinement module 470 may account for optical distortions in images collected by the prediction sensor 410 or the targeting sensor 465, and/or for distortions in angular motions of the implement 475 or the targeting sensor 465 due to nonlinearity of the angular motions relative to object O. Accordingly, the targeting control module may instruct the implement and/or the targeting sensor to point toward the refined location of object O. In some variations, the targeting control module may additionally or alternatively adjust the position of the targeting sensor and/or the implement to follow the object to account for motion of the vehicle while targeting.

In some variations, the targeting sensor may be controlled to engage multiple targets substantially simultaneously. For example, it may utilize a rapid point-to-point movement system to quickly redirect the laser and/or other implements from one target to the next. Additionally or alternatively, the implement may include a multi-beam laser capable of splitting its focus to target several locations in quick succession or even simultaneously, depending on the spatial arrangement of the targets and the capabilities of the laser system. Advanced algorithms within the targeting control module may generate the precise timing and movement patterns to align the laser with each predicted location of the objects. This may enable the targeting sensor to follow a pre-determined path that intersects with the objects at the right moments, considering the continuous movement of the autonomous plant targeting system through the field.

The targeting control module may deactivate the implement after the object has been manipulated (e.g., grabbed, sprayed, burned, or irradiated), after the region including the object has been targeted with the implement, when the object is no longer detected and/or otherwise identified by the prediction system, after a designated period of time has elapsed, and/or any combination thereof. For example, the targeting control module may deactivate a laser emitter after a region on the surface comprising a plant has been scanned by the beam, after the plant has been irradiated or burned, or after the beam has been activated for a predetermined period of time.

### C. Tuning System

In some variations, the detection system in accordance with the present technology may further include a tuning system configured to generate, via a tuning algorithm, a recommended change to one or more parameters that are used by the decision algorithm of the prediction system to instruct an action associated with an object of interest. As described in further detail herein, the tuning system may provide to a user one or more sample images of sample objects representative of objects of interest to be characterized by the prediction system and/or the targeting system, and the tuning system may receive user input regarding the sample objects (e.g., identification of the object type, other object properties, etc.). Based on the user input, the tuning system may recommend one or more adjustments to one or more parameters used by the decision algorithm, to enhance object detection (e.g., optimize a metric of interest, improve accuracy, etc.). In some variations, applying such adjustments does not include modifying the pre-trained identification machine learning algorithm used by the detection system. For example, in some variations, implementing a recommended change to one or more parameters used by the decision algorithm does not include retraining the pre-trained identification machine learning algorithm, thereby advantageously enabling immediate effect of the benefit provided by the adjusted parameters since time does not have to be spent retraining the identification machine learning algorithm itself. Further details regarding the provision of sample images to the user are described in further detail herein, including with respect to methods for enhancing object detection (Section II).

The tuning system may include a system controller, for example a system computer having storage, random access memory (RAM), a central processing unit (CPU), and a graphics processing unit (GPU). The system computer may comprise a tensor processing unit (TPU). The system computer may comprise sufficient RAM, storage space, CPU power, and GPU power to perform operations to analyze sample images and user input regarding the same to generate a recommended change to one or more parameters used by the decision algorithm.

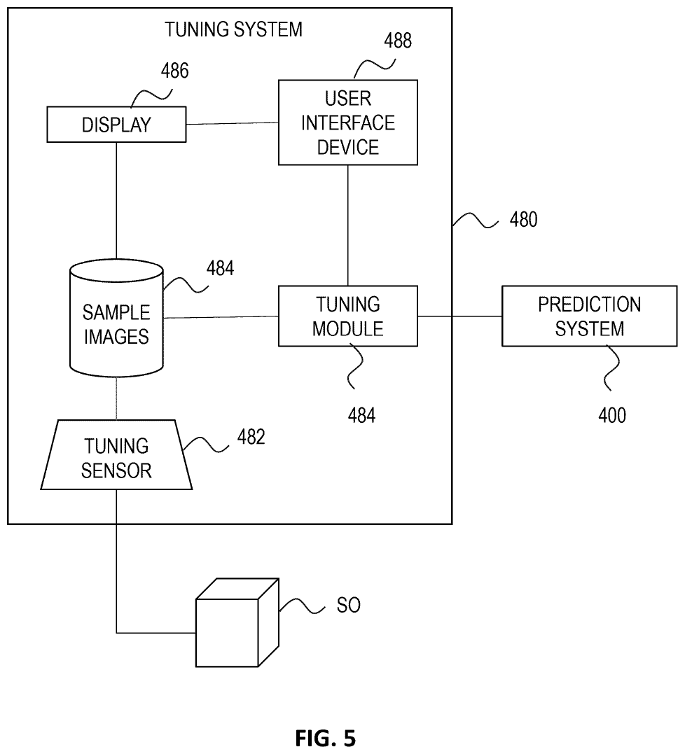

As shown in FIG. 4, in some variations a tuning system 480 can be communicatively and/or otherwise operably coupled to the prediction system 400. An example tuning system 480 is shown schematically in FIG. 5. In some variations, the tuning system may include a tuning sensor 482 configured to collect sample images of a sample object SO, where the sample object is representative of an object of interest to be characterized by the identification machine learning algorithm used by the prediction system (e.g., prediction system 400). Additionally or alternatively, in some variations the sample object SO may be imaged while on a surface (e.g., in a field) that is similar to, or otherwise representative of, the anticipated surface on which the object of interest will be.

In some variations, the tuning sensor may be a camera, such as a charge-coupled device (CCD) camera or a complementary metal-oxide-semiconductor (CMOS) camera, a LIDAR detector, an infrared sensor, an ultraviolet sensor, an x-ray detector, or any other sensor capable of generating an image. In some variations, the tuning sensor may be of similar type as the prediction sensor (e.g., prediction sensor 410) and/or the targeting sensor (e.g., targeting sensor 465). Furthermore, in some variations the tuning sensor may be the same physical sensor as the prediction sensor or the targeting sensor. In some variations, the tuning sensor may be located on an autonomous plant targeting system (e.g., an autonomous plant targeting system that is already in use in a field) so as to provide images of plants in a particular environment of current interest, thereby enabling substantially real-time or immediate adjustments of one or more parameters used by the prediction system associated with the autonomous plant targeting system.

Sample images collected by the tuning sensor may be stored in a sample image memory device, such as sample image memory device 484 shown in FIG. 5. In some variations, the sample images may be stored with tags or other metadata enabling the sample images to be sorted and/or retrieved in accordance with one or more selected properties of the sample objects depicted in the sample images. For example, in some variations, the sample images may be pre-analyzed by the prediction system to identify one or more properties of the sample objects, in a manner similar to how the prediction system may characterize objects of interest in prediction images collected by the prediction sensor. As an illustrative example, the sample images collected by the tuning sensor 482 may depict various sample plants for review by a user, and the prediction system 400 may predict one or more properties of each sample plant, such as a weed score, a crop score, a quantification (e.g., number) of images in which the object is pictured, and/or visual characteristics of the plant (e.g., size, shape, health etc.). Some or all of such predicted properties for a sample plant may be stored (e.g., as metadata) in conjunction with sample image(s) depicting that sample plant.

The tuning system may be configured to provide the sample images to a user and/or prompt the user to provide user input regarding the sample images. For example, as shown in FIG. 5, the tuning system may include (or be communicatively coupled to) a display 486 configured to display one or more of the sample images to the user. The display 486 may, for example, include any suitable computing display, such as on a portable electronic device (e.g., tablet, smartphone, etc.) or monitor. All or a portion of the collected sample images may be provided to the user. For example, only a selected portion of the collected sample images may be curated for display to the user based on one or more previously predicted properties of sample objects depicted among the sample images, date of the sample images, and/or the like.

The tuning system may, in some variations, include a user interface device that enables a user to provide input relating to the sample images, particularly input relating to the sample objects depicted in the sample images (e.g., identifying the object type). For example, as shown in FIG. 5, the tuning system 480 may include a user interface device 488. The user interface device may, for example, include a touchscreen (e.g., integrated in the display 486), a stylus, a computing mouse, keyboard, joystick, and/or the like. For example, the user may provide, via the user interface device, information regarding the identity of the sample object depicted in a sample image and/or other suitable properties of the sample object. The user may select among pre-determined information regarding the sample object (e.g., to confirm a predicted property of the sample object), and/or enter new information regarding the sample object that is depicted in the sample image. In some variations, the user may, for example, identify a sample object (that is potentially a plant) in a sample image as a crop, a weed, type of crop, particular type of weed, particular type of crop, a non-plant (e.g., pest), and/or identify one or more other properties of the sample object (e.g., size, shape, health of the plant, etc.).

A tuning module in the tuning system may receive one or more sample images and input from a user regarding the sample images, so as to analyze the user input in relation to the relevant sample images and generate a recommended change to one or more parameters for use by the decision algorithm of the prediction system. For example, as shown in FIG. 5, the tuning system 480 may include a tuning module 484 that receives sample images from the sample image memory device 484, and information provided through the user interface device 488. The tuning system may include a tuning algorithm configured to generate a recommended change to one or more parameters that is used by a decision algorithm in the prediction system. For example, in variations in which the sample object is a plant, the tuning algorithm may be configured to generate a suggested change to one or more thresholds (e.g., a threshold value against which the weed score is compared, a threshold value against which the crop score is compared, a minimum threshold quantity of images in which the plant should be pictured to permit performance of an action associated with the plant) and/or other assessment of the visual characteristics (e.g., health) of the plant.

In some variations, the tuning algorithm may be configured to generate such recommended change(s) to optimize a predetermined metric of interest (e.g., a default metric of interest, or a user-selected metric of interest), using the user input as a “ground truth” and recommending changes to one or more parameters so that the output of the decision algorithm matches the ground truth. Example metrics of interest include a quantification of weeds detected by the prediction system, a quantification of crops detected by the prediction system, a quantification of weeds targeted by the targeting system, and a quantification of crops to be targeted by the targeting system.

The tuning algorithm can include one or more various suitable algorithms. For example, in some variations, the tuning algorithm may include a rule-based algorithm. As another example, the tuning algorithm may additionally or alternatively include a statistical model, such as Bayesian optimization. Additionally or alternatively, the tuning algorithm may include a machine learning model and/or other algorithm that is separate from the pre-trained identification machine learning model described above with respect to the prediction system. For example, the tuning algorithm may include one or more decision trees, and/or one or more support vector machines. Decision trees can, for example, be advantageous for determining sets of parameters that are important as well as their boundaries. Additionally, support vector machines can be advantageous for separating points with a suitable combination of parameters, and/or for finding relationships between parameters that can separate different classes of items.

In some variations, some or all of the recommended change(s) may be provided to the user for approval to apply to the prediction system's algorithms, though in some variations some or all recommended change(s) may additionally or alternatively be applied to the prediction system's algorithms automatically. The changes recommended by the tuning system may be applied substantially immediately to the decision algorithm without requiring modification of the underlying pre-trained identification machine learning model in the prediction system. Once the change(s) to the decision algorithm are applied, the pre-trained identification machine model can be used to characterize objects of interest in images collected by the prediction sensor, with enhanced performance, such as greater accuracy and/or confidence.

Further aspects of the tuning system are described in further detail with respect to methods for enhancing object detection, as described herein.

### II. Methods for Enhancing Object Detection with Parameter Tuning

In some variations, a method for enhancing object identification and targeting performed by a pre-trained machine learning algorithm may be used in connection with a tuning system in accordance with the present technology. For example, a method for enhancing object detection (e.g., identification and targeting) may be performed with any of the systems described herein with respect to FIGS. 1-5.

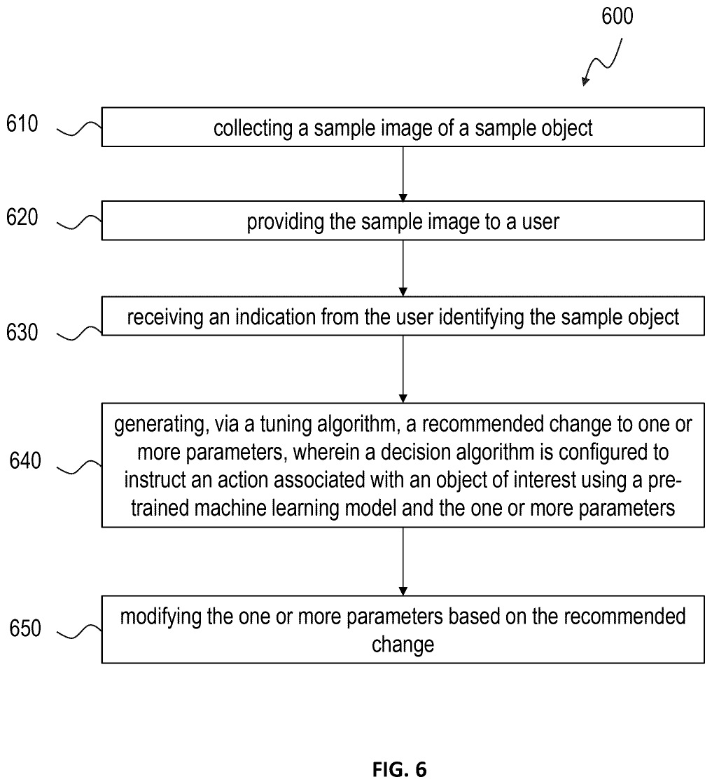

FIG. 6 is a schematic illustration of an example method 600 for enhancing object detection in accordance with the present technology. As shown in FIG. 6, the method 600 may include collecting a sample image of a sample object 610, providing the sample image to a user 620, receiving an indication from the user identifying the sample object 630, and generating, via tuning algorithm, a recommended change to one or more parameters 640 that are used by a decision algorithm for identifying and targeting objects of interest. In some variations, the method 600 may further include modifying the one or more parameters based on the recommended change 650. Further aspects of the method for enhancing object detection are described below.

The method 600 may be used to enhance object detection by enabling adjustment of parameter(s) used by a decision algorithm, where the decision algorithm is configured to instruct an action associated with an object of interest using a pre-trained identification machine learning model and the one or more parameters. For example, in some variations in which the object of interest is a plant, the pre-trained identification machine learning model may be configured to detect objects of interest (plants) in images collected by a prediction sensor, and/or one or more properties of the plant of interest (e.g., a weed score, a crop score, a quantification (e.g., number) of images in which the object is pictured, and/or visual characteristics of the plant (e.g., size, shape, health etc.). The decision algorithm may be configured to instruct an action (e.g., to manipulate an implement such as an implement 475, or to refrain from implementing the implement) associated with the plant of interest. As described elsewhere herein, the decision algorithm may do so based on the properties of the detected objects (as predicted by the identification machine learning model) and one or more parameters, such as one or more thresholds (e.g., a threshold value against which the weed score is compared, a threshold value against which the crop score is compared, a minimum threshold quantity of images in which the plant should be pictured to permit performance of an action associated with the plant) and/or other assessment of the visual characteristics of the plant. In some variations, visual characteristics of the plant may be represented by a numerical representation in the form of an embedding (e.g., feature vector), such that similar-looking plants may have similar embeddings and different-looking plants have dissimilar embeddings. Other example aspects of the identification machine learning model (e.g., as performed by the object identification module, such as object identification module 420 described with respect to FIG. 4) are described further elsewhere herein.

As an illustrative example, the decision algorithm may be configured with an initial set of parameters (weed score threshold, crop score threshold, and minimum percentage of images in which the item was detected), as shown in Table 1 below.

TABLE 1

| Parameter | Value |
|---|---|
| Weed score threshold | 50% |
| Crop score threshold | 40% |
| Minimum % of collected images in | 60% |
| which plant of interest is detected | |

In deciding what action to take with respect to any given plant of interest, the decision algorithm may compare the predicted properties of the plant of interest to one or more of the parameters in Table 1. For example, for a plant of interest having a predicted weed score of 90% in 8 out of 10 collected images, the predicted weed score threshold satisfies the weed score threshold and the number of images in which the plant of interest is identified satisfies the minimum percentage of images in which the plant of interest should be pictured to take action associated with the plant of interest (high confidence). Accordingly, the decision algorithm may characterize the plant of interest as a targeted weed, and instruct the targeting system to target the plant of interest with an implement (e.g., laser) to damage the plant of interest. As a second example, for a plant of interest having a predicted crop score of 80% in 7 out of 10 collected images (high confidence), the decision algorithm may similarly characterize the plant of interest as a crop, and instruct the targeting system to refrain from targeting the plant of interest with an implement to damage the plant of interest. As a third example, for a plant of interest having a predicted weed score of 30% in 9 out of 10 collected images (low confidence), the decision algorithm may instruct the targeting system to refrain from targeting the plant of interest (which may be a weed, but may be a desirable crop) with the implement.

While these example parameters may be sufficient in certain scenarios, it may be desirable to adjust one or more of the parameters to achieve a desired outcome (e.g., increase accuracy and/or consistency of object detection and targeting) for object identification and targeting. Accordingly, a tuning algorithm in accordance with the present technology may be utilized to generate a recommended change to one or more parameters. Implementing the recommended change(s) may be performed without retraining or otherwise modifying the underlying pre-trained, identification machine learning model itself.

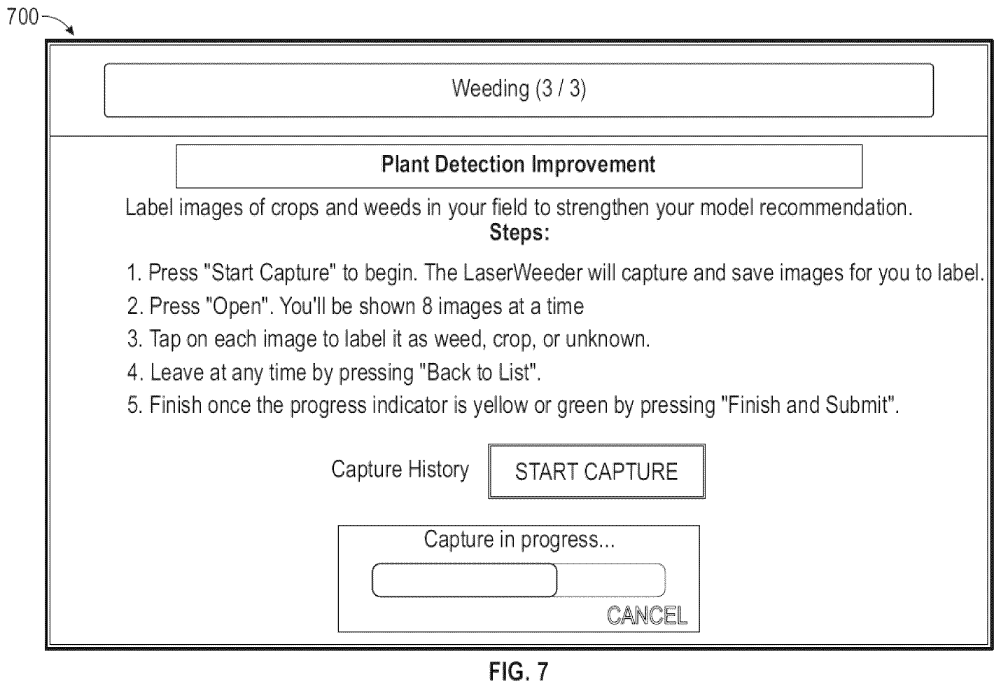

In some variations, the method for enhancing object identification and targeting may be commenced by entering the detection system in a tuning mode. In some variations, the tuning mode may be entered in response to a user input. For example, FIG. 7 shows an example user interface 700 on a display (titled “Plant Detection Improvement” that includes a brief description of the tuning process, including instructions to begin collecting images by pressing a “Start Capture” button on the user interface. The user may, for example, elect to enter the detection system in the tuning mode if the user believes the detection system has been identifying and/or targeting objects (e.g., plants) in an unsatisfactory manner.

Additionally or alternatively, in some variations, the tuning mode may be entered (or a prompt may be provided to a user to enter the tuning mode) for calibration purposes, such as during an initial setup of the detection system in a new detection environment (e.g., a new field of crops), on a periodic basis (e.g., every week, every month, every three months, every six months, every year), on any suitable intermittent basis, and/or in response to changing conditions (e.g., changing weather patterns). The user may, in some variations, establish a desired custom calibration schedule for the tuning mode to be entered.

### A. Collecting Sample Images

As described above, the method 600 may include collecting a sample image of a sample object 610, which may include collecting one or more sample images of one or more sample objects. For example, each of the one or more sample images may depict one or more sample objects. In some variations, the sample images may be collected with a tuning sensor (e.g., tuning sensor 482) similar to, or is the same as, the prediction sensor used by the prediction system and/or the targeting sensor used by the targeting system.

In some variations, a sample object may be representative of (and in some variations, identical to) at least one object of interest to be characterized by the pre-trained identification machine learning model. For example, the sample object may share one or more properties as an object of interest (e.g., is a crop, weed, etc.). In some variations, the sample objects are in the same environment as the objects of interest, such as in the same field of crops in which the autonomous plant targeting system is currently being used.

In some variations, multiple sample images may be collected over a predetermined period of time, such as while a vehicle carrying the tuning sensor traverses an environment of sample objects. For example, sample images may be collected across a predetermined period of time such as one minute, two minutes, five minutes, ten minutes, thirty minutes, one hour, two hours, five hours, twelve hours, one day, etc. Additionally or alternatively, multiple sample images may be collected for a predetermined travel distance (or area of travel) for a vehicle carrying the tuning sensor. For example, sample images may be collected across a predetermined travel distance (e.g., 5 meters, 10 meters, 25 meters, 50 meters, 100 meters, 500 meters, etc.) and/or a predetermined area of travel (e.g., 5 square meters, 10 square meters, 25 square meters, 50 square meters, 100 square meters, etc.). For example, collecting sample images may include collecting sample images of sample plants as an autonomous plant targeting system with the tuning sensor is moving throughout a field of objects of interest over a predetermined period of time, travel distance, and/or area of travel. As another example, collecting sample images may include collecting sample images as long as the vehicle is entered in a particular operational mode (e.g., weeding mode, “scanning” mode). In some variations, the device mode may be manually toggled on and/or off as a user desires, turned on for a predetermined period of time, and/or automatically turned on and/or off depending on environmental conditions (e.g., when there is a sufficient amount of ambient light). As another example, collecting sample images may include collecting sample images whenever the vehicle is in a particular physical configuration (e.g., a “lowered” configuration when the tuning sensor is located closer to the ground where sample objects are located). As another example, collecting sample images may include collecting images whenever the vehicle is in a particular location (e.g., particular predetermined region of a field). Any of the above examples may, for example, be a user-selected mode for the sample image collection process, such as depending on user preferences for sample object type, degree of sample object variety, and/or collection time for sample images.

The collected sample images may be analyzed by the prediction system (e.g., prediction system 400) to predict one or more properties (e.g., weed score, crop score, size, shape, etc.) of sample objects in the sample images. Such predicted properties of the sample objects may be used, for example, to help ensure enough sample images are collected for purposes of the tuning algorithm. Furthermore, obtaining the predicted properties of the sample objects may help ensure sufficient variety of sample objects are shown among the sample images, which can improve the robustness of the tuning. In some variations, the method may include collecting information regarding how representative every sample object is of other objects of interest in the environment (e.g., field), which can further improve the robustness of the tuning.

The collected sample images may be stored in one or more suitable memory devices (e.g., image memory device 484), and may be tagged or otherwise associated with various object properties (e.g., as metadata) so that the sample images may be sorted and retrieved according to a desired object property. Additionally or alternatively, in some variations, some or all of the collected sample images may be periodically or intermittently refreshed in the memory device(s), so as to conserve memory space, prioritize more recent sample images, prioritize sample images depicting particular sample objects of interest (e.g., plant types that are more frequently mis-identified or whose identification is generally associated with a lower confidence level), prioritize sample image taken under certain environmental conditions, etc. For example, in some variations, whenever sample images are collected, the method may include keeping a predetermined or user-selected number (e.g., 500, 1000, etc.) of the most recent sample images and deleting the rest. As another example, the method may include deleting a predetermined or user-selected number (e.g., 500, 1000) of the oldest sample images to create memory space for new images. As another example, the method may include deleting older images on a rolling basis as new images are collected, to maintain a collection of sample images of a maximum size (e.g., 5000 total sample images). Any of the above examples may, for example, be a user-selected mode for the sample image collection process, such as depending on user preferences (e.g., for optimizing memory storage).

### B. Providing Sample Images to a User

As described above, the method 600 may include providing the sample image to a user 620, which may include providing one or more sample images of one or more sample objects (e.g., sample objects collected in the collection process 610 described herein). In some variations, the sample images may be provided to a user on a suitable display, such as display 486. The display may, for example, be incorporated in a portable electronic device such as a tablet, mobile phone, smart watch, laptop, and/or on any suitable computing device such as on a desktop computer.

In some variations, only a portion of the collected images are displayed or otherwise provided to a user. For example, providing the sample images to the user may include displaying only those sample images that depict a sample object being associated with a selected object property, such as a particular size, particular shape, particular other visual characteristic, particular predicted action such as targeting that would be performed on the sample object, etc. Furthermore, any two or more object properties may be applied in combination to filter for a desired subset of collected images for display to the user. As another example, providing the sample images to the user may include providing a random subset of sample images from the set of collected sample images.

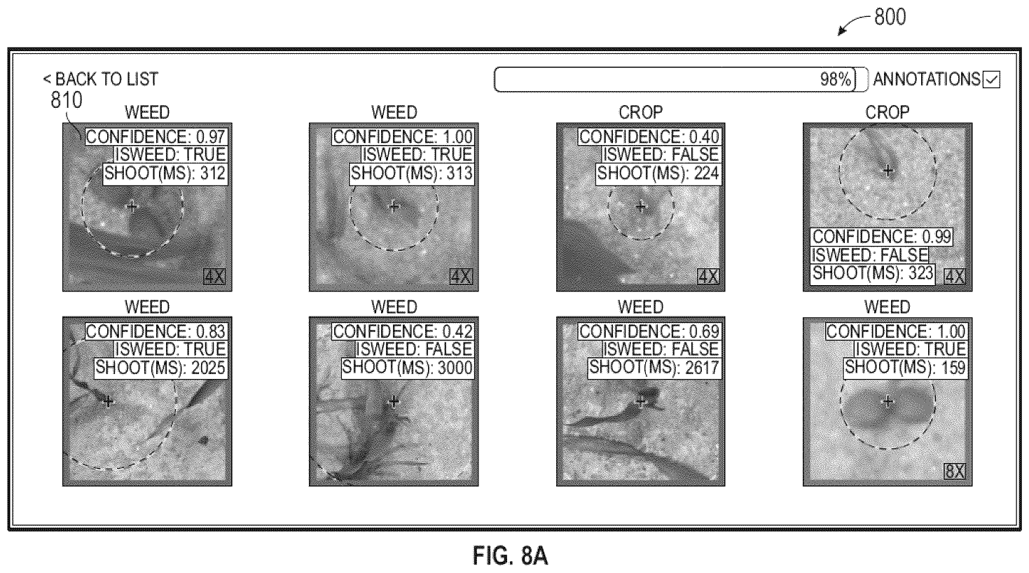

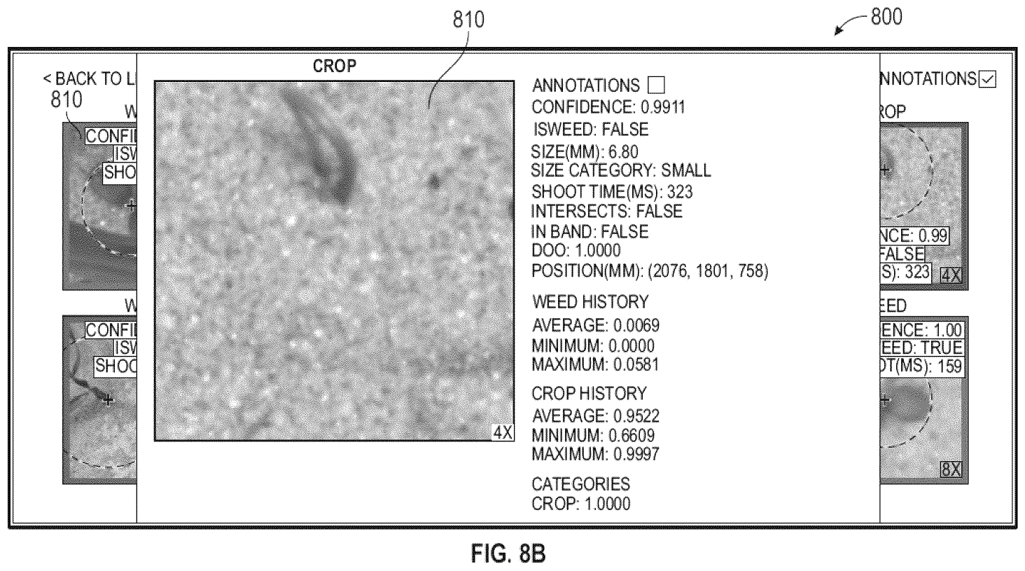

The sample images may be provided on a display to a user with any suitable user interface. For example, FIG. 8A illustrates an example user interface 800 simultaneously displaying a set of multiple sample images 810, such as in a grid. In some variations, additional information such as predicted object properties for a sample object in a particular sample image 810 may also be displayed overlaid or adjacent to the sample image 810, such as predicted object type (e.g., weed, crop, type of weed, type of crop, etc.). However, in some variations some or all of such additional information may be omitted from display, which may, for example, help avoid biasing the user when the user is providing input in identifying the sample object. In some variations, once the user provides an indication identifying the sample object, the user-provided or user-confirmed information may be displayed overlaid or adjacent to the sample image 810.

In some variations, a sample image 810 in the grid may be selected for an enlarged or detailed display, which may help the user to review more detailed features of the sample object in the image 810. For example, a sample image 810 may be individually selected and displayed in an enlarged view, as shown in FIG. 8B. Similar to that described above with reference to FIG. 8A, additional information such as predicted object properties for the sample object in the enlarged sample image 810 may also be displayed overlaid or adjacent to the sample image 810. However, in some variations some or all of the additional information may be omitted from display (and any information regarding the sample object that is provided or confirmed by the user may later be displayed overlaid or adjacent to the sample image 810).

Additionally or alternatively, in some variations each of the sample images may be displayed individually, such as one at a time in series. For example, thumbnails of sample images may be arranged in a virtual image carousel that the user can scroll through, and individual sample images may automatically be displayed for review by the user, and/or the user may select any individual sample image for display and review by the user. As another example, each individual sample image may be automatically displayed in series (and optionally, with a prompt to the user requesting the user to identify the displayed object), with the next sample image in the sequence not being displayed until sufficient user input has been received for the currently displayed sample image.

### C. Receiving User Input

As described above, the method 600 may include receiving an indication from the user identifying the sample object 630 in the one or more sample images. The user may be viewing the sample images (either as a group set such as in a grid, or individually, etc.). In some variations, the user may be prompted to provide an indication identifying the one or more sample objects that are shown in each sample image. For example, the user may enter a label that is assigned or otherwise associated to each sample object. The label may be entered in various manners. For example, the sample image may be prepopulated with a label (e.g., “crop”, “weed”, specific type of crop, specific type of weed) and the user may enter an indication either confirming that the prepopulated label is accurate for the sample object, or correcting the prepopulated label by entering an updated label for the sample object. In some variations, the prepopulated label may be assumed to be accurate unless corrected by the user. As another example, the user may select a label from a prepopulated set of available labels, and associate the selected label with a sample object. In some variations, the prepopulated list may include all possible labels of an object of interest, or only a subset of possible labels if the identification machine learning model has narrowed down the list of potential labels that are likely to be correct for the sample object. As another example, the user may freely enter a label (e.g., via a keyboard) to be associated with the sample object.

The label for a sample object may be shown on the display in any suitable manner. For example, FIG. 8A illustrates an example user interface 800 in which sample images 810 are accompanied by a text label (e.g., “weed”, “crop”) adjacent to each sample image. The label for each sample image may additionally or alternatively be displayed overlaid with the sample image, may include color coding (e.g., a first text color associated with “weed”, a second text color associated with “crop”). Additionally or alternatively, an outline or border for each sample image may be configured to reflect the labeling of the sample object shown therein. For example, depending on the label (e.g., “weed”, “crop”, etc.) associated with the sample image, the appearance of the outline or border for the sample image may differ (e.g., in color, line weight, line pattern, etc.).

In some variations, a confidence score for the user-provided labeling may be collected, where the confidence score indicates the level of certainty with which the user has identified the sample object in the sample image. The confidence score for the user-provided labeling may, for example, be used by the tuning algorithm when generating recommended change(s) to one or more parameters. When sample images have relatively higher confidence scores, it may be appropriate to assume that those sample images are more likely to have accurate labels, and thus should be weighted more by the tuning algorithm when generating recommended changes to one or more parameters. Conversely, when sample images have relatively lower confidence scores, it may be appropriate to assume that those sample images are less likely to have accurate labels, and thus should be weighted less by the tuning algorithm when generating recommended changes to one or more parameters.

In some variations, the confidence score for the user-provided labeling may be based at least in part on the time taken for the user to identify the sample object, and/or on an indication of the user vacillating between multiple labels (e.g., number of times a pending label is changed, prior to submitting a final label indicating identity of the sample object. Additionally or alternatively, the confidence score for the user-provided labeling may be based at least in part on embeddings (e.g., feature vectors) for the labeled sample objects. For example, if multiple labeled sample objects have very similar feature vectors (e.g., as characterized by a suitable similarity measure) but a particular one of these labeled sample objects has a different label than the other labeled sample objects, then the confidence score for that differently-labeled sample object may be reduced. Conversely, if multiple labeled sample objects have very different feature vectors but have the same label, then the confidence score for the same-labeled sample objects may be reduced. Additionally or alternatively, the confidence score for the user-provided labeling may be based at least in part on input from the user regarding their confidence in their label for a sample object. For example, the user may enter a quantitative rating of their confidence in their label as a number between “1” and “4” (e.g., “1” indicates “very unsure”, “2” indicates “somewhat unsure”, “3” indicates “somewhat sure”, and “4” indicates “very sure”), and/or may enter a similar qualitative description of their confidence in their label.

### D. Generating Recommended Changes to One or More Parameters

As described above, the method 600 may include generating a recommended change to one or more parameters via a tuning algorithm 640. Generally, the tuning algorithm may be configured to tune one or more parameters used by the decision algorithm, based on the user input identifying the sample object(s) in the sample image(s) and the stored object properties of the sample object(s).

In some variations, the tuning algorithm is configured to recommend a change to one or more parameters to optimize a predetermined metric of interest. The predetermined metric of interest may be a default metric of interest (e.g., in accordance with a calibration protocol), or may be a user-selected metric of interest. In variations in which the tuning algorithm is configured to recommend a change to parameter(s) relating to plant detection, example metrics of interest include but are not limited to number of weeds targeted, number of crops targeted, number of weeds detected (regardless of whether the plant is targeted), number of crops detected (regardless of whether the crop is targeted), and combinations any two or more metrics (e.g., average of number of weeds detected and number of crops detected). For example, in some variations it may be desirable to tune one or more parameters of the decision algorithm in order to maximize the number of weeds the decision algorithm instructs for targeting. As another example, in some variations it may be desirable to tune one or more parameters of the decision algorithm in order to maximize the number of weaker crops the decision algorithm instructs for targeting (e.g., for crop thinning).

In some variations, the tuning algorithm may include a rule-based algorithm to generate a recommended change to one or more parameters. The rule-based algorithm may, for example, evaluate the decision outcome of the decision algorithm across every combination of relevant parameter values, and select a combination of parameter values that result in the desired decision outcome (e.g., that maximizes a certain metric of interest). As an illustrative embodiment for plant targeting, a sample plant may be defined as a targeted weed for damaging if (1) the sample object's weed score is greater than a weed score threshold for at least a minimum percentage of sample images in which the sample plant is detected, and (2) the sample object's crop score is lower than a crop score threshold for at least a minimum percentage of sample sample images in which the sample plant is detected.

The decision outcomes of the decision algorithm using every combination of (i) possible weed score thresholds (e.g., between 0 and 1, such as at 0.1 or 0.05 increments), (ii) possible crop score thresholds (e.g., between 0 and 1, such as at 0.1 or 0.05 increments), and (iii) possible minimum percentage values of sample images in which the sample plant is detected, may be determined. The pool of potential parameter combinations (out of all possible parameter combinations) may be reduced by filtering for parameter combinations resulting in desirable decision outcomes (e.g., filtering to keep parameter combinations result in crops_targeted being less than 2%, where crops_targeted is the percentage of plants that were labeled as a crop and also targeted). Furthermore, the optimum parameter combination may be the combination where the outcome weed_targeted is the highest among the parameter combinations (e.g., in the filtered pool of potential parameter combinations), where weeds_targeted is the percentage of plants that were labeled as a weed and also targeted. Accordingly, the recommended parameters may include a new value for weed score threshold and/or a new value for crop score threshold.

As another example, the tuning algorithm may additionally or alternatively include a statistical model-based algorithm, such as a Bayesian optimization algorithm, to generate a recommended change to one or more parameters used by the decision algorithm.

As another example, the tuning algorithm may additionally or alternatively include a pretrained tuning machine learning model to generate a recommended change to one or more parameters used by the decision algorithm. The tuning machine learning model may, for example, include a suitable deep learning algorithm (e.g., convolutional neural network), and/or other suitable machine learning algorithm (e.g., decision trees, support vector machines). The tuning machine learning model may be separate from the identification machine learning model.

### E. Modifying the One or More Parameters

As described above, the method 600 may include modifying the one or more parameters based on the recommended change to one or more parameters. For example, the recommended change in parameter(s) used by the decision algorithm may be applied, such that the decision algorithm may evaluate properties of objects of interest using the updated parameters. For example, in some variations, the decision algorithm may include comparing object properties (e.g., as determined by the detection system, such as detection system 400) to the updated parameters, which results in decision outcomes for objects of interest that prioritize the metric of interest.

In some variations, the recommended change in parameter(s) is applied automatically after the tuning algorithm provides the recommended changes. For example, the recommended change in parameter(s) may be implemented immediately after being identified by the tuning algorithm, or once a predetermined period of time has elapsed after being identified (e.g., an hour, thirty minutes, fifteen minutes, ten minutes, five minutes, one minute, thirty seconds, etc.) by the tuning algorithm. In some variations, the recommended change in parameter(s) may be applied only after the user approves of the recommended changes (e.g., via a user interface on a display. The recommended change in parameter(s) may be adopted without retraining or otherwise modifying the identification machine learning model.

Object detection (e.g., via the identification machine learning model and the decision algorithm) may subsequently proceed with the decision algorithm using the new, updated parameters.

### III. Methods for Enhancing Object Detection Using Comparison of Embeddings

In some variations, a method for enhancing object identification and targeting performed by a pre-trained machine learning model may be performed with an autonomous plant targeting system. For example, a method for enhancing object detection (e.g., identification and targeting) may be performed with any of the systems described herein with respect to FIGS. 1-5.

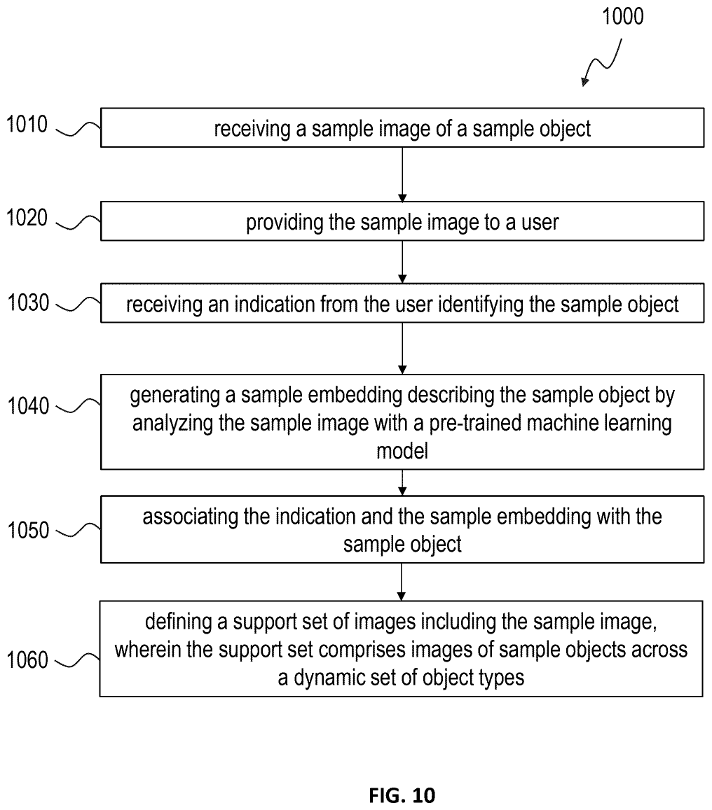

FIG. 10 is a schematic illustration of an example method 1000 for enhancing object detection in accordance with the present technology. As shown in FIG. 10, the method 1000 may include receiving (e.g., collecting or otherwise obtaining) a sample image of a sample object 1010, providing the sample image to a user 1020, receiving an indication from the user identifying the sample object 1030, generating a sample embedding with a pre-trained machine learning model 1040, associating the indication and the sample embedding with the sample object 1050, and defining a support set of images including the sample image 1060, where the support set includes images of sample objects across a dynamic set of object types into which objects of interest may be classified.

In general, a pre-trained identification machine learning model may be trained to classify objects as one of a set of predefined types, or classes (e.g., identify a plant of interest as among one of broadleaf, grass, offshoot, purslane, and crop classes). As described elsewhere herein, a decision algorithm may be applied based on an output of the pre-trained identification machine learning model to determine an action that may be taken with respect to an object of interest (e.g., target a plant identified as a weed to be damaged or killed). However, it may be desired, after training of the identification machine learning model, to target objects that are not in one of those predefined classes, and/or target objects with finer granularity (e.g., adjust actions to be taken with respect to a specific grass type, without affecting how actions may be taken with respect to other grass types).

The dynamic set of object types referenced in method 1000 may be dynamic in the sense that the number of object types represented in the support set of images (and among the object types the pre-trained machine learning model may classify objects of interest) may change without requiring retraining of the pre-trained identification machine learning model. For example, a sample object may be identified by a user as being a new, user-defined object type that the pre-trained identification machine learning model was not previously trained on. The user-defined object type may be based in taxonomy (e.g., desired species type, etc.) and/or may be arbitrary. As described elsewhere wherein, the pre-trained identification machine learning model may be trained to characterize one or more parameters (e.g., visual properties such as size, shape, etc.) of objects, and store a numerical representation of the parameter(s) in an embedding (e.g., feature vector). As such, the pre-trained identification machine learning model may be configured to analyze a sample image of a new sample object that is labeled or otherwise identified by a user as belonging to a new object type or class, and then generate a sample embedding for the sample object. The pre-trained identification machine learning model may then generate an embedding for a subsequent unknown object of interest. If the embedding for the object of interest is similar (in metric space) to the sample embedding for the new sample object, then the pre-trained identification machine learning model may identify the unknown object of interest as of the same object type as the new sample object, without requiring retraining of the pre-trained machine learning model. Of course, the pre-trained identification machine learning model may identify the unknown object of interest as of the same object type as any other pre-defined object type (including those on which the pre-trained identification machine learning model actually was explicitly trained on), if the embedding of the unknown object of interest is more similar to an embedding associated with any other such pre-defined object type.

In some variations, a user may tailor the behavior of an autonomous plant targeting system using method 1000, for example to treat a certain type of plant with greater specificity. As an illustrative example, there are many types of lettuce that may be grown as a crop, and the pre-trained identification machine learning model may be trained to treat all lettuces in an identical manner collectively. A user (farmer) who wishes to maintain only romaine lettuce in their field may initially be limited by the pre-trained identification machine learning model to treat romaine and non-romaine lettuce crops in their field in an identical manner. However, the user may utilize method 1000 to define specifically romaine lettuce as a newly defined object type, and thus refine the algorithms of the autonomous plant targeting system to treat only lettuces that look like romaine as crops, but treat other lettuce types as weeds (and target them to damage or kill all non-romaine lettuce). In this manner, the user may gain specificity in maintaining romaine lettuce while targeting to damage or kill all non-romaine lettuce, despite the pre-trained identification machine learning model being trained to treat all lettuce types the same.

Accordingly, the method 1000 may enhance the ability of a pre-trained identification machine learning model to identify or classify objects of interest across a set of object types that may change (e.g., expand) dynamically over time, without retraining the identification machine learning model between when a newly-defined object type is added (or removed) and when the identification machine learning model is able to identify an object of interest as being of the newly-defined object type. Thus, the method 1000 may enable more operational flexibility of the identification machine learning model. For example, a user may, even without requiring specialized knowledge for training a machine learning model, increase the accuracy and/or precision with which the identification machine model identifies objects of interest. Additionally or alternatively, a user may enable the identification machine learning model to identify an object of interest that may not have been present or known when the identification machine learning model was being trained. Furthermore, the method 1000 facilitates updates to the object identification process in a manner that is much faster than retraining the identification machine learning model (which may, in some instances, otherwise take several days).

### A. Collecting Sample Images

As described above, the method 1000 may include receiving a sample image of a sample object 1010. In some variations, receiving a sample image may be similar to collecting a sample image of a sample object 610 as described herein with respect to FIG. 6. For example, the sample image may depict a sample object that is representative of (and in some variations, identical to) at least one object of interest to be characterized by the pre-trained identification machine learning model. In some variations, the sample image is of a sample object that is not yet of a defined object type classifiable by the pre-trained identification machine learning model, but is an object type that is to be newly defined by a user.

In some variations, one or more such sample images may be collected over a period of time, such as while a vehicle carrying a prediction sensor (e.g., camera) and/or targeting sensor (e.g., camera) traverses an environment of sample objects. For example, an image may be collected by normal course of operation by the prediction sensor or targeting sensor as described above, and initially analyzed by a pre-trained identification machine learning model as described herein. In some variations, if the identification of type of object depicted in the image is somewhat inconclusive, then the image may be designated a sample image for purposes of method 1000. For example, in some instances the identification machine learning model may determine that the object in the image is predicted as somewhat equally likely to be any of multiple object types (e.g., predicted probability of the object being a first object type and predicted probability of the object being a second object type are within 5%, 10%, 15%, 25%, or any suitable margin within each other). In such instances, the image may be designated a sample image for use in method 1000. Additionally or alternatively, in some instances the identification machine learning model may not be able to predict that the object in the image is any particular object type it knows of (e.g., if the object is not close enough to any particular object type). In such instances, the image may be designated a sample image for use in method 1000.

Additionally or alternatively, in some variations, one or more sample images may be collected in response to a user command. For example, the user may be an operator of a vehicle controlling movement of the prediction sensor and/or targeting sensor, and the user may position the vehicle such that the sample object is in the field of view of the prediction sensor and/or targeting sensor. The user may desire to collect a sample image of the sample object for supplementing the support set with a new object type, so in response to a user command (e.g., input to display 486 or other user input device) a sample image may be taken by the prediction sensor and/or targeting sensor when the sample image is in the appropriate field of view.

Additionally or alternatively, a sample image may be taken from a library of pre-existing images (e.g., from training images used as training data, images used for diagnostic testing, etc.).

### B. Providing Sample Images to a User

As described above, the method 1000 may include providing the sample image to a user 1020, which may include providing one or more sample images of one or more sample objects (e.g., sample objects collected in the collection process 1010 described herein). In some variations, providing the sample image to a user 1020 may be similar to providing sample images 620 as described herein with respect to FIG. 6. For example, in some variations, the sample images may be provided to a user on a suitable display, such as display 486. The display may, for example, be incorporated in a portable electronic device such as a tablet, mobile phone, smart watch, laptop, and/or on any suitable computing device such as on desktop computer.

### C. Receiving User Input

As described above, the method 1000 may include receiving an indication from the user identifying the sample object 1030 in the sample image. In some variations, receiving such user input including the indication identifying the sample object may be similar to receiving an indication from the user 630 as described herein with respect to FIG. 6. For example, the user may be viewing the sample images (either as a group set such as in a grid, or individually, etc.). In some variations, the user may be prompted to provide an indication identifying the one or more sample objects that are shown in each sample image. For example, the user may enter a label that is assigned or otherwise associated to each sample object, such as by freely entering a label (e.g., via a keyboard) to be associated with the sample object. In other words, in some variations, object types (e.g., classes) may be created at will by the user, and the sample image may be assigned to any of such new object types by the user based on user input. Additionally or alternatively, the user may assign the sample image to an object type by selecting from a pre-populated list of object types that may be known from taxonomy (though the pre-trained identification machine learning model may or may not have been trained to identify), such as from a drop-down list or search function.

After the indication identifying the sample object is received, the indication may be associated with the sample image (e.g., as part of process 1050).

### D. Generating a Sample Embedding

As described above, the method 1000 may include generating a sample embedding 1040 with a pre-trained identification machine learning model. The sample embedding may be generated by inputting the sample image into a pre-trained identification machine learning model, which is trained to output an embedding with one or more parameters characterizing the sample object. As described elsewhere herein, the sample embedding may, in general, include a numerical representation of the visual appearance of the sample object, and may include, for example, information relating to size and/or shape of the sample object (e.g., number of leaves, shape of leaves, orientation of leaves, distinctive leaf features, color, etc.). The sample embedding may, for example, include numerical representations that indirectly characterize the visual appearance of the sample object (e.g., incorporate visual information representative of the visual appearance of the sample object), and may or may not necessarily directly characterize the visual appearance of the sample object (e.g., explicitly enumerate quantitative aspects, such as number of leaves). Further details regarding the training of the identification machine learning model are described below.

After the sample embedding is generated, the sample embedding may be associated with the sample image (e.g., as part of process 1050).

### E. Defining a Support Set of Images

As described above, the method 1000 may include defining a support set of images including the sample image 1060. The process 1060 may include generating and/or updating the support set of images. The support set includes images that may, for example, be used as examples that are used by the pre-trained identification machine learning algorithm for classification of objects of interest, where the images are sorted into different categories as depicting objects of different object types. For example, in some variations, a first portion of the support set may be treated as example images depicting a first plant type, a second portion of the support set may be treated as example images depicting a second plant type, and so on. The support set may include at least the object types that were used to train the pre-trained identification machine learning algorithm.

The support set may include images of sample objects across a dynamic set of object types, where the population (e.g., total number and kinds) of object types may dynamically change over time without retraining the pre-trained identification machine learning algorithm. For example, in some variations the support set may, in addition to (or as an alternative to) one or more pre-defined object types used to train the pre-trained identification machine learning algorithm, the support set may include one or more object types correlating to the label or other identification provided by the user in process 1030 for the sample images.

An object of each image of the support set may have an associated object type (e.g., label or class) and an associated embedding characterizing the visual appearance of the object in the image. As described in further detail herein, the embedding generated by the pre-trained identification machine learning model for an object of interest can be compared to one or more embeddings associated with objects represented in the support set, to identify the object of interest as an appropriate object type based on similarity of the embeddings.

In some variations, the support set may additionally or alternatively be used to adjust the pre-trained identification machine learning model, though such adjustments to the model itself may not be necessary. For example, the support set images may be used to determine weights for a weighted K-nearest neighbors (KNN) algorithm, and/or determine a better value for K in the KNN algorithm.

### F. Identifying an Object of Interest

A method of identifying an object of interest using a pre-trained identification machine learning model may leverage the support set of images as generated and/or updated in method 1000. The object of interest may, for example, be predicted to be one of the object types represented in the support set of images generated and/or updated as described above with respect to FIG. 10.

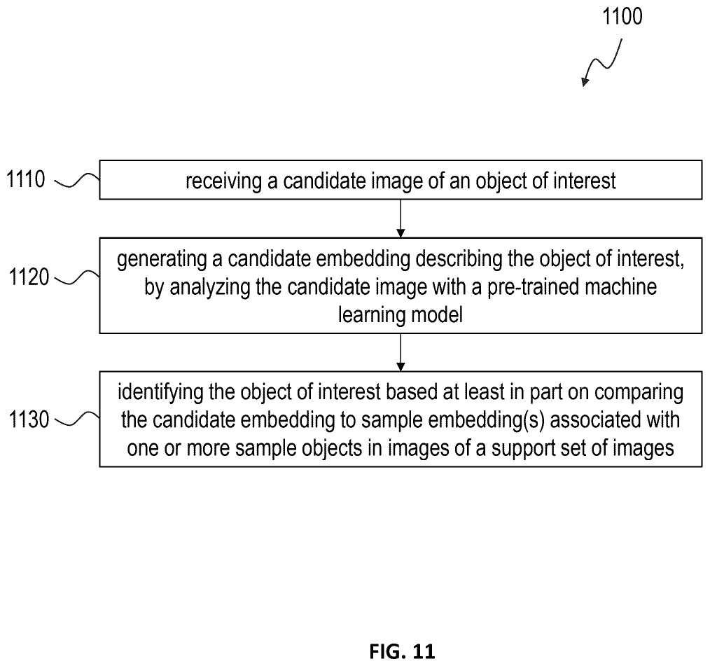

For example, FIG. 11 is a schematic illustration of a method 1100 for identifying an object in accordance with the present technology. The method 1100 may include receiving a candidate image of an object of interest 1110 and generating a candidate embedding describing the object of interest 1120 by analyzing the candidate image with a pre-trained machine learning model (e.g., the same pre-trained machine learning model referenced in method 1000). The method 1100 may further include identifying the object of interest 1130 based at least in part on comparing the candidate embedding to one or more sample embeddings associated with one or more sample objects in the images of the support set of images.

Receiving a candidate image of an object of interest 1110 functions to receive an image of an object whose identity is to be predicted using the pre-trained machine identification machine learning model. The candidate image may, for example, be an image that is collected by a sensor of an autonomous plant targeting system, such as a prediction sensor (e.g., camera) such as prediction sensor 410, or any other sensor (e.g., tuning sensor 482, targeting sensor 465). The candidate image may be collected as the autonomous plant targeting system moves within an environment such as through a field including plants of interest (e.g., weeds, crops, etc.). Further details regarding the collection of an image of an object of interest are described herein.

Generating a candidate embedding 1120 with the pre-trained identification machine learning model functions to generate a numerical representation of the visual appearance of the object of interest (e.g., size, shape, health, etc.), thereby describing the plant in numerical terms. The pre-trained identification machine learning model may be configured to generate an embedding characterizing the object of interest based on the candidate image of the object of interest received as an input. Example methods of training such a pre-trained identification machine learning model are described herein.

Identifying the object of interest 1130 functions to predict the object type of the object of interest using the candidate embedding. For example, the pre-trained identification machine learning model may be configured to compare the candidate embedding to one or more sample embeddings generated from images in the support set of images (e.g., as generated and/or updated as described above with respect to FIG. 10). In general, the pre-trained identification machine learning model may be configured to identify the sample embedding(s) to which the candidate embedding is most similar, and output the object type for such sample embedding(s) as likely object types for the object of interest.

In some variations, the pre-trained identification machine learning model may be configured to output a probability or likelihood that the object of interest is of one or more identified object types, which may function similar to a confidence level for identifying the object of interest. As described herein, in leveraging a support set that may include images of object types that were not pre-defined for use in training the identification machine learning model, the identification machine learning model may be configured to identify objects of interest in any of a dynamic set of object types, including user-defined object types.

In some variations, the pre-trained identification machine learning model may utilize a distance-based algorithm to compare candidate embeddings to sample embeddings associated with imaged objects of the support set. The pre-trained identification machine learning model may incorporate various classification methods utilizing distance metrics. For example, in some variations the pre-trained identification machine learning model may include a KNN algorithm, a neural network (e.g., convolutional neural network) trained to take embeddings as input and output an object type (e.g., class), or a decision tree or random forest algorithm trained to classify objects based on embeddings.

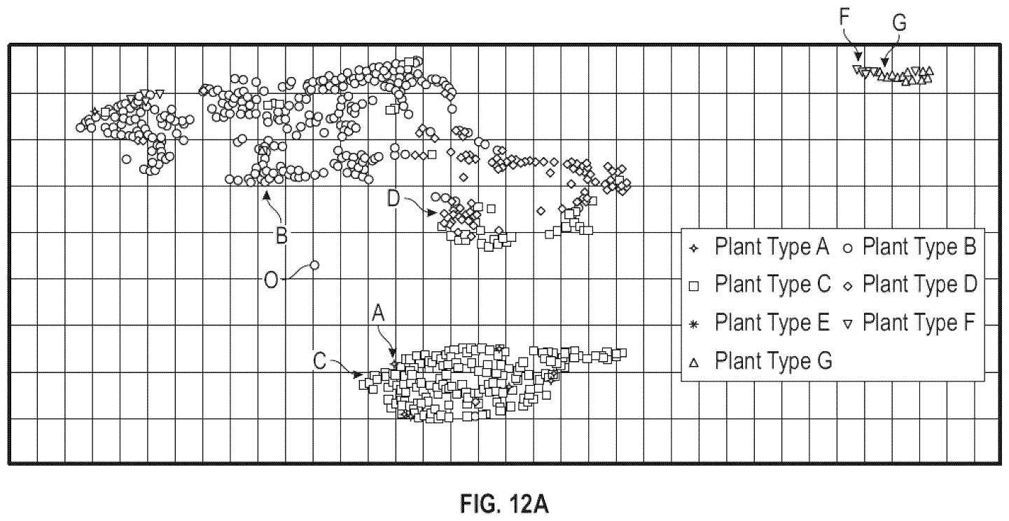

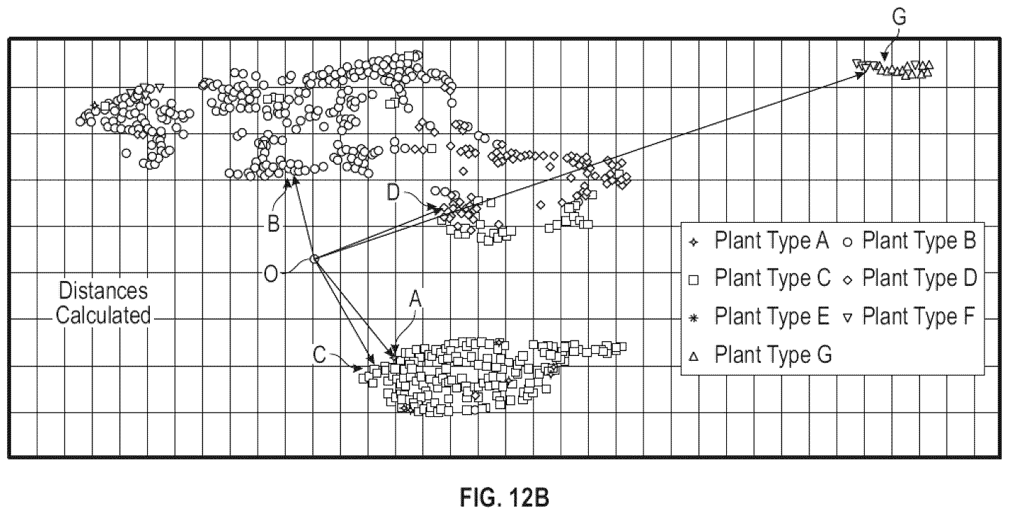

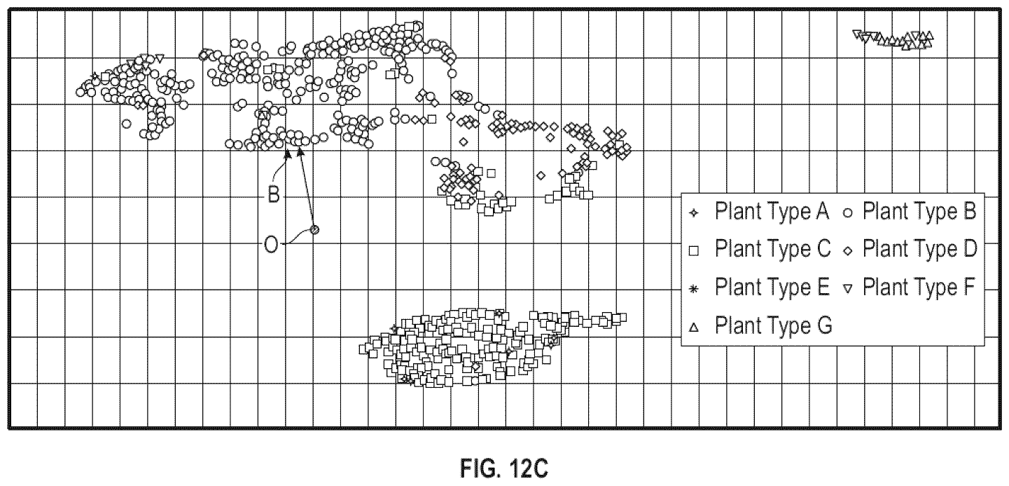

FIGS. 12A-12C illustrate the use of an example KNN algorithm to identify a plant of interest (e.g., classify the plant of interest as a particular plant type). FIG. 12A illustrates a feature space including dots representing where embeddings of various plants reside in the feature space, based on images of plants in the support set of images. Dots are generally clustered in the feature space based on similarity of embeddings represented by the dots. For example, plants of plant type B generally have similar embeddings, and are represented by dots clustered together in the left corner of FIG. 12A, while plants of plant type C also generally have similar embeddings, and are represented by dots clustered together in lower half of FIG. 12A. There may be overlap between some clusters of plant types that share some visual characteristics. For example, plant type B may be broadleaf while plant type D may be grass; some broadleaf may resemble grass so some dots corresponding to broadleaf may be present in the main cluster for plant type D, and vice versa. In FIG. 12A, a plant of interest to be identified is represented as point O, which is not clearly located within any particular cluster of dots. As such, FIG. 12A illustrates an instance in which the plant of interest represented by an embedding located at point O is not immediately clearly any one of Plants A-G.

To identify the plant type that the plant of interest is most similar to, the KNN algorithm may calculate the distance between the embedding of the plant of interest and other embeddings of other plant types. For example, FIG. 12B illustrates distances calculated between the embedding of point O and each of a representative embedding of plant types A, B, C, E, and G (other distances may additionally or alternatively be calculated). FIG. 12C illustrates the identification of the distance between the embedding of point O and a representative embedding of plant type B as being the shortest. Accordingly, the KNN algorithm may determine, based on this shortest distance which indicates greatest similarity between the embedding of plant type B and the embedding of the plant of interest, that the plant of interest is most likely to be plant type B.

Although FIGS. 12A-12C illustrate identifying a plant of interest with a KNN algorithm that compares the candidate embedding of an object of interest to sample embeddings of objects imaged in the support set images, it should be understood that other suitable identification machine learning models (e.g., neural network, decision tree, random forest, etc.) may additionally or alternatively be used to identify the object of interest as one of the object types in the support set (e.g., without retraining the identification machine learning model between updating or generating the support set, and identifying the object of interest using a candidate embedding). Furthermore, the candidate embedding may be compared to one or more sample embeddings by additionally or alternatively utilizing any one or more suitable algorithms, including but not limited to support vector machine (SVM) algorithms, classification algorithms, and/or regression algorithms.

Similar to that described elsewhere herein, after the object of interest is identified using the pre-trained identification machine learning model, a decision algorithm may determine an action to be taken with respect to the object of interest, such as based at least in part on the object type of the object of interest.

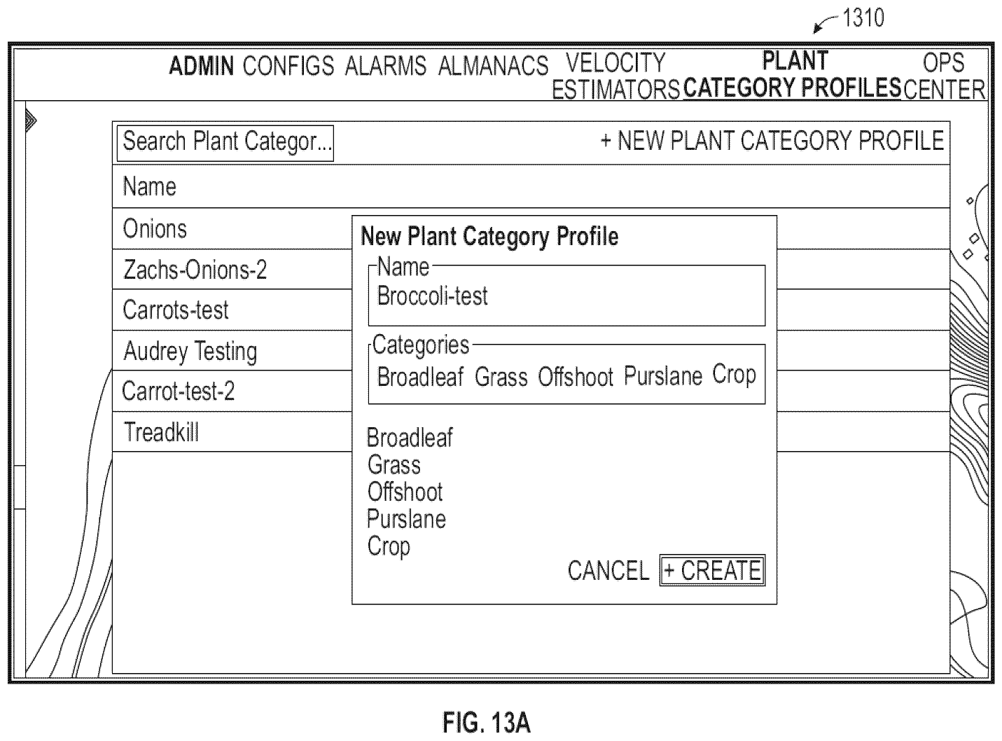

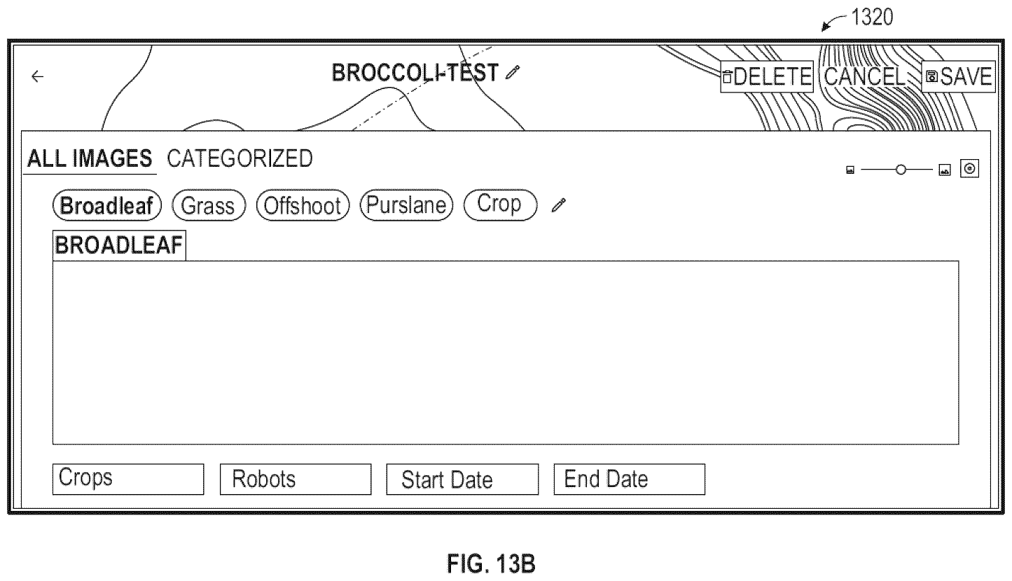

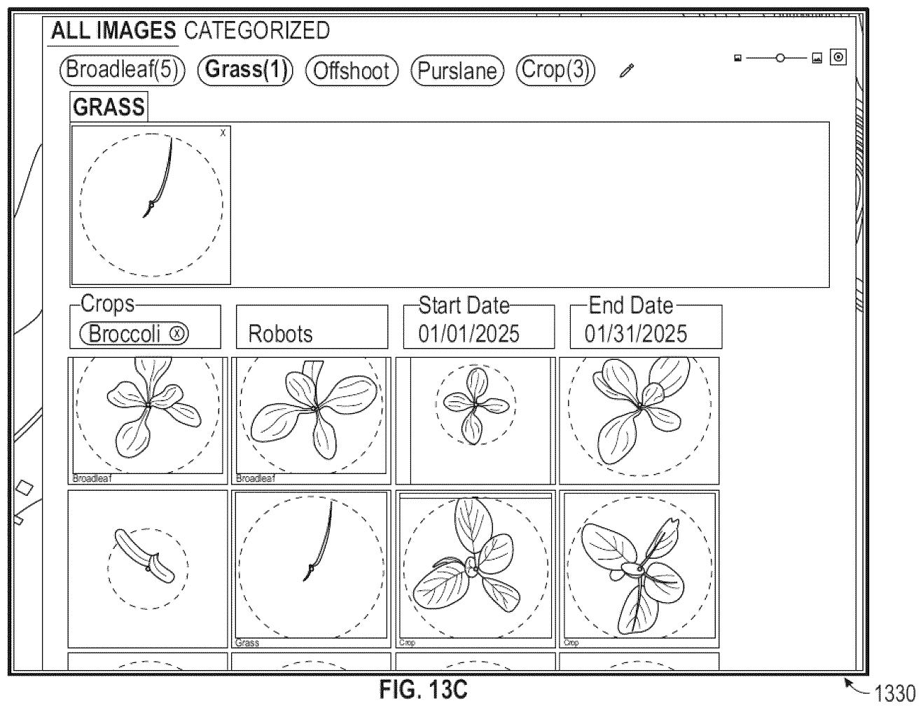

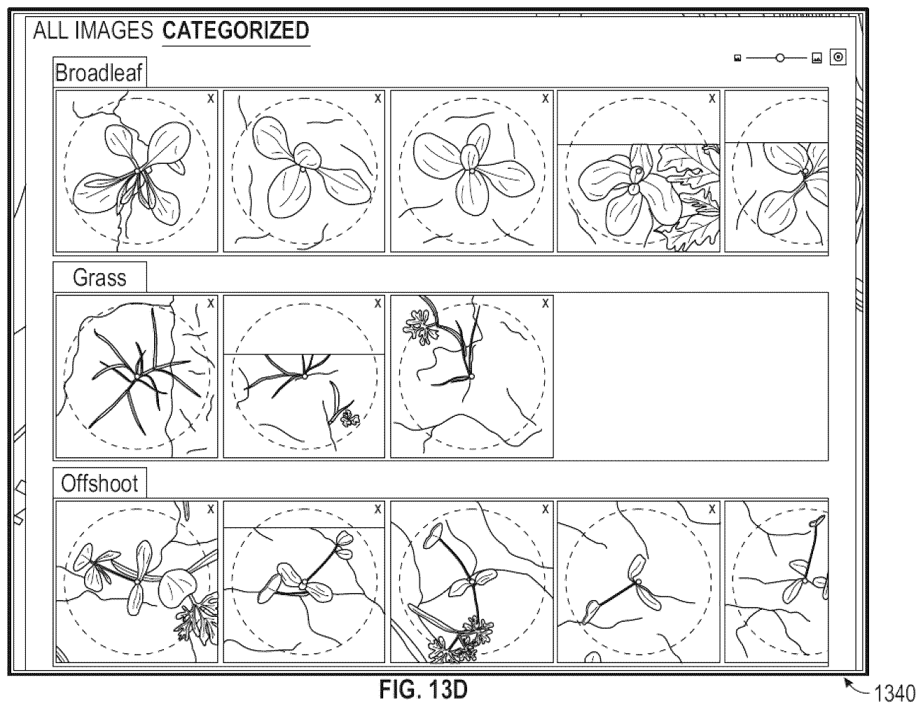

The methods 1000 and/or 1100 may, as described herein, involve user interaction, such as with a display (e.g., display 486) that is configured to provide sample images to a user for labeling and/or other identification of object type of sample objects shown in the sample images. FIGS. 13A-13D depict example graphical user interfaces (GUIs) for user interaction with the autonomous plant targeting system. For example, FIG. 13A illustrates a GUI 1310 in which a user may indicate the creation of a new plant type or category profile (e.g., such that the autonomous plant targeting system may identify a plant of interest as the new user-defined plant type). The new plant type may supplement a pre-existing (e.g., default or otherwise previously created) set of plant types. For example, in the variation shown in FIG. 13A, a new plant type of “broccoli” may be created, to add to a set of possible plant types including broadleaf, grass, offshoot, purslane, and a broader crop plant category.

FIGS. 13B and 13C illustrate a GUI 1320 and a GUI 1330, respectively, in which support set images corresponding to various plant types may be viewed. For example, support set images of one or more certain plant types may be viewed upon selecting and filtering for such certain plant type(s). Specifically, FIG. 13B illustrates an empty set of broadleaf images that is awaiting to be populated with support set images depicting broadleaf. FIG. 13C illustrates a set of one support set image depicting grass, as well as various support set images depicting broccoli (as labeled or otherwise indicated by the user, for example). In some variations, each of the support images may be cropped, colorized, and/or otherwise processed to focus framing and/or image details of a particular sample plant of the relevant plant type.

In some variations, the support set images of various plant type(s) may be reviewed and/or edited. For example, FIG. 13D illustrates a GUI 1340 in which support set images for each plant type of broadleaf, grass, and offshoot may be reviewed. An individual support set image may be selected for more detailed review, and may, in some variations, be confirmed by a user as depicting a plant that belongs to its designated plant type. Additionally or alternatively, an individual support set image may be selected by a user for deletion (and/or reassignment to a different plant type) if the user believes that the image depicts a plant that does not belong to its designated plant type and/or if the user is uncertain about the accuracy of the designated plant type. Additionally or alternatively, a user may manually select other images (e.g., from a suitable image source library) to add to the support set of images and designate each of such additional image(s) as belonging to a particular plant type.

It should be understood that the GUIs shown in FIGS. 13A-13D are illustrative examples only, and the visual appearance of user interfaces for a user to define a new object type, and/or to generate and/or update a support set of images with sample images, may vary while being consistent with the present invention.

### IV. Training the Identification Machine Learning Algorithm

Example methods for training an identification machine learning algorithm are described below. Once trained to predict the identity of an object of interest based on an image, the identification machine learning model may be used to identify any suitable object of interest, including with respect to the methods described herein (e.g., method 600, method 1000, method 1100). For example, the identification machine learning mode may be trained to receive an image of an object of interest as an input, and output an embedding characterizing the visual appearance of the object of interest.

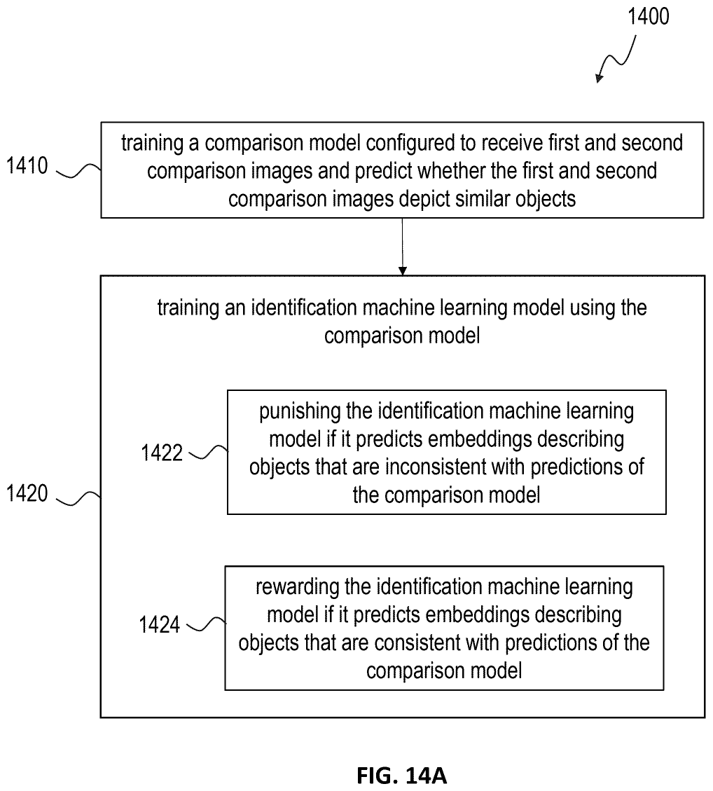

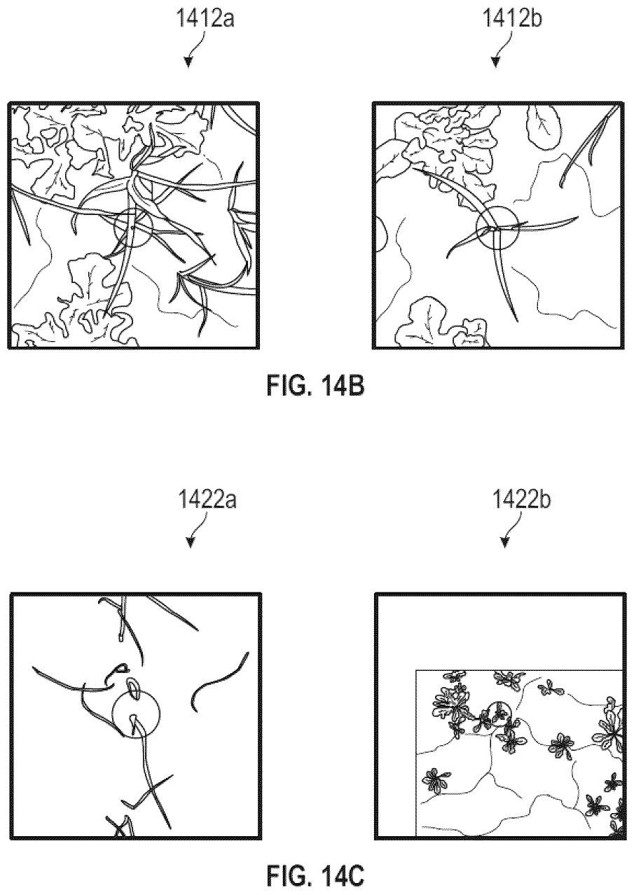

FIG. 14 is a schematic illustration of an example method 1400 for training an identification machine learning model. In general, method 1400 may involve training a comparison model configured to predict similarity of two images objects, and using the comparison model as a reference against which to train (e.g., optimize) the identification machine learning model. For example, method 1400 may include training a comparison model configured to receive first and second comparison images and predict whether the first and second comparison images depict similar objects. An example of comparison images is shown in FIG. 14B, which includes a first comparison image 1412a of a first plant of a certain plant type and a second comparison image 1412b of a second plant of the same plant type. Alternatively, the first and second comparison images may depict plants of different plant types. The comparison model may be trained, using any suitable technique with a training set of comparison images, to receive such first and second comparison images and predict the degree to which the two imaged objects in the comparison images are similar. For example, the comparison model may output a similarity score between 0 and 1, where 0 indicates high likelihood that the images depict different plant types, and 1 indicates high likelihood that the images depict the same plant type.

The method 1400 may further include training an identification machine learning model using the comparison model 1420. For example, the identification machine learning model may be iteratively refined by inputting training images into the identification machine learning model and the comparison model, then punishing or rewarding the identification machine learning model based on whether its predictions are consistent with the predictions of the comparison model. Specifically, for example, the method may include punishing the identification machine learning model 1422 if it predicts embeddings describing objects that are inconsistent with predictions of the comparison model. Additionally or alternatively, the method may include rewarding the identification machine learning model 1424 if it predicts embeddings describing objects that are consistent with predictions of the comparison model. For example, when inputting the images 1422a and 1422b (which depict plants of different plant types) shown in FIG. 14C into the identification machine learning model and the comparison model, identification machine learning model should be punished if its embeddings for the plants in the two images are similar (since the imaged plants are actually substantially different, and the comparison model is trained to identify them as such), but rewards if its embeddings for the plants in the two images are different. Over repeated iterations, the embeddings predicted by the identification machine learning model should in general agree with or be consistent with the output of the comparison model.

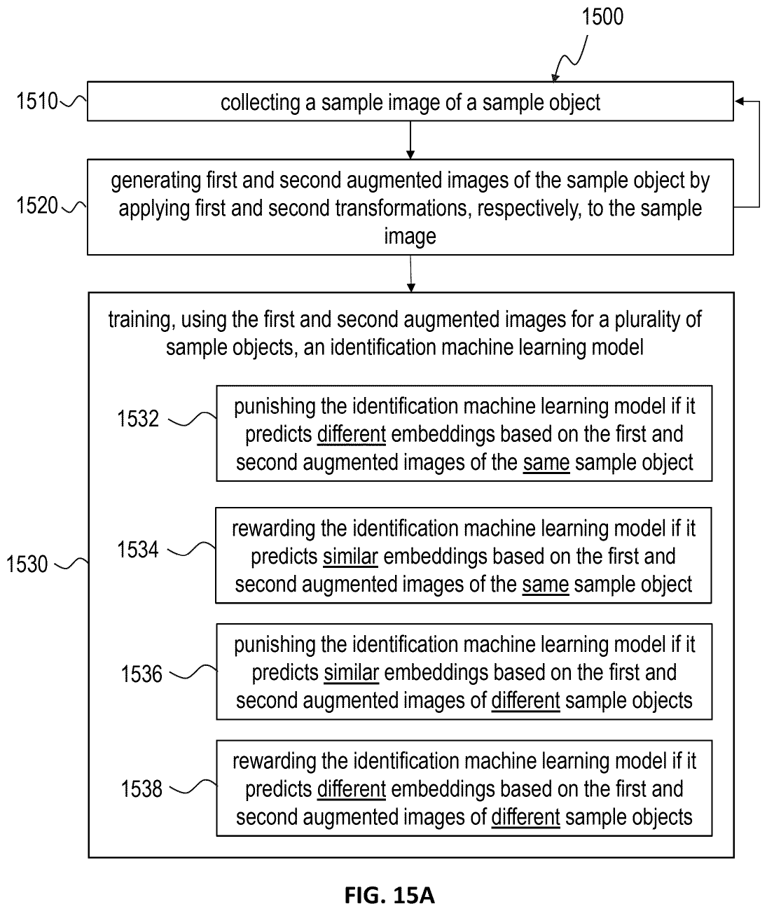

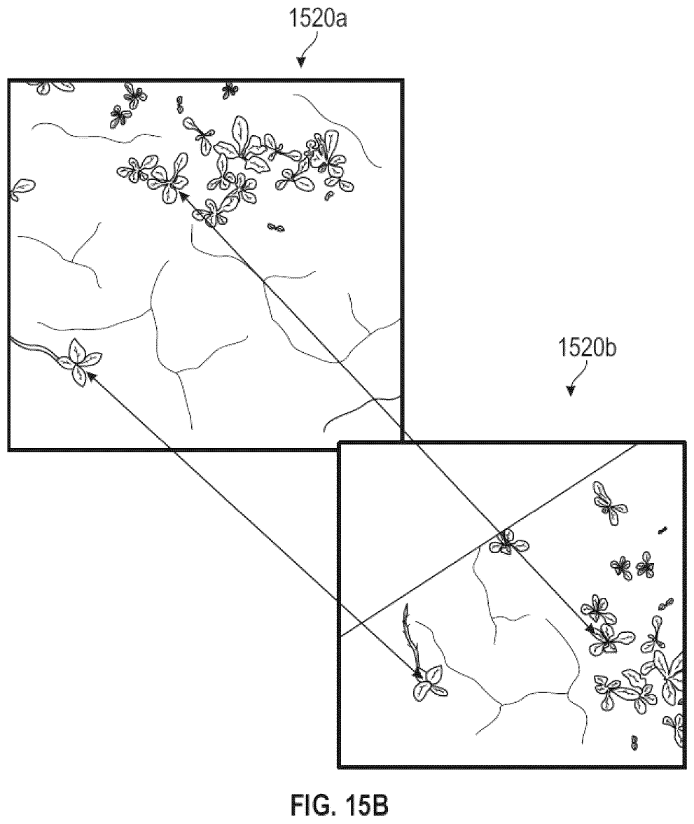

FIG. 15A is a schematic illustration of an example method 1500 for training an identification machine learning model. In general method 1500 may involve training an identification machine learning model with an augmented loss. For example, method 1500 may include collecting a sample image of a sample object 1510 (e.g., similar to other image collecting processes described herein), and generating first and second augmented images of the sample object 1520 by applying first and second transformations, respectively, to the sample image. Examples of transformations include rotation, color distortion (e.g., changes in saturation, brightness, contrast, etc.), scaling, and image cropping, though other transformations may be suitable for generating the augmented images. Furthermore, more than two augmented images may be generated for each sample image, and each augmented image may include one, two or any suitable number of individual transformations. For example, FIG. 15B illustrates an example augmented image 1520b including both a rotation and a color distortion of a sample image 1520a.

The method 1500 may further include training an identification machine learning model using the first and second augmented images for a plurality of sample objects 1530. For example, in general, the model may be punished if it predicts different embeddings for different augmented images of the same plant and/or predicts similar embeddings for different augmented images of different plants. For example, as shown in FIG. 15A, the method may include: (i) punishing the identification machine learning model if it predicts different embeddings based on the first and second augmented images of the same sample object 1532; (ii) rewarding the identification machine learning model if it predicts similar embeddings based on the first and second augmented images of the same sample object 1534; (iii) punishing the identification machine learning model if it predicts similar embeddings based on the first and second augmented images of different sample objects 1536; and (iv) rewarding the identification machine learning model if it predicts different embeddings based on the first and second augmented images of different sample objects 1538.

### V. Related Applications

As described herein, in some variations of the present technology, user input regarding sample images may be used by a tuning algorithm to enhance object detection. However, in some variations user input may additionally or alternatively be used in other applications with respect to object detection. Several examples of such applications are described below.

### A. Directed targeting

As described elsewhere herein, the detection system may utilize an identification machine learning model that is configured to predict one or more properties of objects including specific object categories, and the targeting system may utilize a decision algorithm to decide whether to target a particular object of interest. However, the identification machine learning model may be pre-trained such that it identifies an object as one of a predetermined set of object categories at a broader level of specificity than a user may desire for their particular application. For example, with respect to plant detection such as with an autonomous plant targeting system, the identification machine learning model may be configured to predict a predetermined set of weed categories (e.g., grass, broadleaf, etc.). However, a user may wish to customize the autonomous plant targeting system to handle weeds with more granularity or specificity than what is available in the predetermined set of weed categories (e.g., another weed category, such as purslane).

In some variations, a method for enhancing object detection may enable the detection system to target object categories that the detection system's identification machine learning model is not explicitly trained to recognize. Such a method may be similar to method 600 described above with respect to FIG. 6, except as described below. For example, the method may include collecting one or more sample images of one or more sample objects (e.g., similar to process 610), providing the one or more sample images to a user (e.g., similar to process 620) and receiving an indication (e.g., label) from the user identifying the one or more sample objects (e.g., similar to process 630). As described above, the collected sample images may be analyzed by the identification machine learning model to predict various properties of the sample objects, including an embedding for each sample object that is a numerical representation corresponding to the visual appearance of the sample object. As such, each sample object labeled by the user will have its own embedding. Subsequently, when the detection system is in operation handling new objects of interest, the decision algorithm may be configured to compare the embedding of an object of interest to the embedding(s) of the labeled sample objects, with the goal of aligning the system's assessment of the object of interest with how the user would assess the object of interest. For example, in some variations the decision algorithm may compare the embedding of a plant of interest to the embeddings of labeled sample plants to determine whether the user would consider the plant of interest a weed or a crop, and then target the plant of interest accordingly. In some variations, this operation of the decision algorithm can lead to different targeting outcomes without modifying (e.g., retraining) the identification machine learning model itself.

### B. Labeler Feedback

In some variations, the model(s) in the detection system (e.g., identification machine learning model) may be trained using training data including training images that are labeled by third party operators who are not familiar with the use environment. For example, with respect to plant detection with an autonomous plant targeting system, training images for the identification machine learning model may be labeled for model training purposes by operators remote from or isolated from the farms on which the autonomous plant targeting system will be used. Because such operators lack firsthand field knowledge of the farm on which the autonomous plant targeting system will be used, their labels may be inaccurate, which can have a detrimental effect on model performance.

In some variations, sample images labeled by a user who is localized to the use environment (e.g., farmer or other personnel associated with the field in which an autonomous plant targeting system will be used) may be used to provide feedback for model training purposes. For example, the method may include collecting one or more sample images of one or more sample objects (e.g., similar to process 610), providing the one or more sample images to a user (e.g., similar to process 620) and receiving an indication (e.g., label) from the user identifying the one or more sample objects (e.g., similar to process 630). As described above, the collected sample images may be analyzed by the identification machine learning model to predict various properties of the sample objects (e.g., weed score, crop score, etc.).

Once the labeled sample images are obtained, some or all of the labeled sample images may be used for training purposes. For example, in an instance where the sample object whose predicted properties are inconsistent with the user-provided label for the sample object (e.g., identification machine learning model predicted the sample plant to be a crop, but user identified the sample plant as a weed), the sample image(s) depicting that sample object may be added to future training data sets, thereby improving the accuracy and/or consistency of future iterations of the identification machine learning model, decision algorithm (and/or other algorithms used by the detection system). As another example, the user-labeled sample images may be provided to third party operators who are performing other labeling (e.g., for the identification machine learning model), such that the operators can use the sample images as a reference point for their own labeling. For example, if a plant was labeled as grass by a user (e.g., farmer or other personnel associated with the field in which an autonomous plant targeting system will be used), then a third party operator can recognize that any plants that look similar to that plant are likely to be grass as well.

### C. Model A/B Testing

Different versions of a particular model in the detection system (e.g., identification machine learning model) can lead to different detection outcomes. When evaluating model performance, it may be advantageous to compare performance of different models in detecting objects in the same image data. For example, it may be desirable to compare the performance of multiple different development models against a control, to evaluate which development model is performing better.

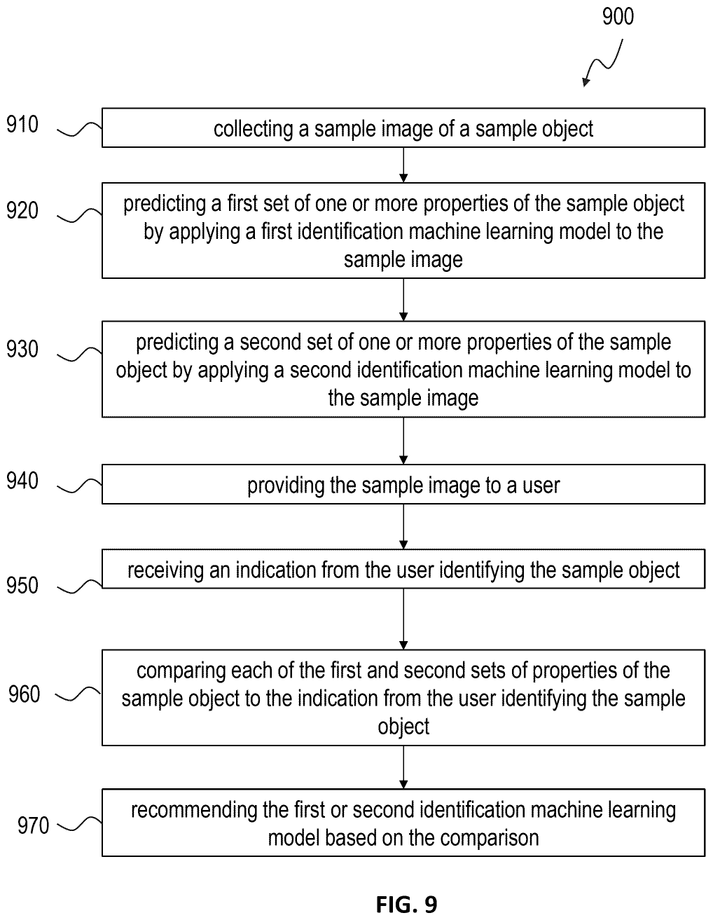

In some variations, sample images labeled by a user may function as a control against which different development models (e.g., identification machine learning model A, identification machine learning model B) can be compared. FIG. 9 illustrates an example method 900 for evaluating model performance. As shown in FIG. 9, the method 900 may include collecting a sample image of a sample object 910, predicting a first set of one or more properties of the sample object by applying a first identification machine learning model to the sample image 920, and predicting a second set of one or more properties of the sample object by applying a second identification machine learning model to the sample image 930. Generally, collecting the sample image of the sample object 910 can be similar to process 610 described above with respect to method 600 and FIG. 6, except that some or all of the sample images are separately analyzed by a first identification machine learning model (in process 920) and/or a second identification machine learning model (in process 930). For example, in some variations every sample image may be analyzed by both the first and second identification machine learning models (e.g., every one of sample images 1-n may be passed through both an identification machine learning model A and an identification machine learning model B). As another example, the identification machine learning models may analyze the sample images in a divided (e.g., alternating or interleaved) manner, such that a first portion of the collected sample images is analyzed by the first identification machine learning model, and a second portion of the collected sample images is analyzed by the second identification machine learning model (e.g., sample image 1 may be passed through an identification machine learning model A only, sample image 2 may be passed through an identification machine learning model B only, sample image 3 may be passed through the identification machine learning model A only, etc.). Each sample image analyzed in such a manner may be tagged or otherwise associated with (e.g., via a table) the particular identification machine learning model(s) (e.g., identification machine learning model A and/or identification machine learning model B) that have analyzed the sample image, so as to track the performance of a particular identification machine learning model with respect to that sample image.

The method may further include providing the sample image to a user 940 (similar to process 620), receiving an indication from the user identifying the sample object 950 (e.g., similar to process 630), comparing each of the first and second sets of properties of the sample object to the indication from the user identifying the sample object 960, and recommending the first or second identification machine learning model based on the comparison 970. For example, comparing the first and second sets of sample object properties to properties identified or confirmed by the user can function to evaluate which identification machine learning model performs more closely to the control properties provided by the user. The identification machine learning model that predicts sample object properties most similar to those provided by the user may be considered as the best-performing model (and recommended as such).

### CONCLUSION

Although many of the variations are described above with respect to systems, devices, and methods for autonomous plant targeting, the technology is applicable to other applications and/or other approaches. Moreover, other variations in addition to those described herein are within the scope of the technology. Additionally, several other variations of the technology can have different configurations, components, or procedures than those described herein. A person of ordinary skill in the art, therefore, will accordingly understand that the technology can have other variations with additional elements, or the technology can have other variations without several of the features shown and described above with reference to FIGS. 1-15B.

The descriptions of variations of the technology are not intended to be exhaustive or to limit the technology to the precise form disclosed above. Where the context permits, singular or plural terms may also include the plural or singular term, respectively. Although specific variations of, and examples for, the technology are described above for illustrative purposes, various equivalent modifications are possible within the scope of the technology, as those skilled in the relevant art will recognize. For example, while steps are presented in a given order, alternative variations may perform steps in a different order. The various variations described herein may also be combined to provide further embodiments.

As used herein, the terms “generally,” “substantially,” “about,” and similar terms are used as terms of approximation and not as terms of degree, and are intended to account for the inherent variations in measured or calculated values that would be recognized by those of ordinary skill in the art.

Moreover, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. Additionally, the term “comprising” is used throughout to mean including at least the recited feature(s) such that any greater number of the same feature and/or additional types of other features are not precluded. It will also be appreciated that specific variations have been described herein for purposes of illustration, but that various modifications may be made without deviating from the technology. Further, while advantages associated with certain variations of the technology have been described in the context of those variations, other variations may also exhibit such advantages, and not all variations need necessarily exhibit such advantages to fall within the scope of the technology. Accordingly, the disclosure and associated technology can encompass other variations not expressly shown or described herein.

1.-101. (canceled)

102. A method comprising:
providing a sample image of a sample object to a user;
receiving an indication from the user identifying the sample object as a user-created object type;
generating a sample embedding describing the sample object by analyzing the sample image with a pre-trained machine learning model;
associating the indication and the sample embedding with the sample object;
defining a support set of images including the sample image, wherein the support set comprises one or more images of sample objects across a dynamic set of one or more object types including the user-created object type;
receiving a candidate image of an object of interest;
generating a candidate embedding describing the object of interest by analyzing the candidate image with the pre-trained machine learning model;
identifying the object of interest based at least in part by comparing the candidate embedding to one or more sample embeddings associated with the one or more sample objects in the images of the support set.

103. The method of claim 102, wherein the pre-trained machine learning model is not re-trained between generating the sample embedding and generating the candidate embedding.

104. The method of claim 102, wherein the sample embedding comprises one or more predicted properties of the sample object, and wherein the candidate embedding comprises one or more predicted properties of the object of interest.

105. The method of claim 104, wherein the one or more predicted properties of the object of interest comprises at least one of size or shape of the object of interest.

106. The method of claim 104, wherein the one or more predicted properties of the candidate embedding comprises a first object score representing likelihood that the object of interest is a first object type.

107. The method of claim 106, wherein the first object type is a crop and the method further comprises instructing an implement to not damage the object of interest.

108. The method of claim 106, wherein the first object type is a crop and the method further comprises instructing an implement to damage the object of interest.

109. The method of claim 104, wherein the one or more predicted properties of the candidate embedding further comprises a second object score representing likelihood that the object of interest is a second object type.

110. The method of claim 109, wherein the second object type is a weed and the method further comprises instructing an implement to damage the object of interest.

111. The method of claim 102, wherein comparing the candidate embedding to one or more sample embeddings comprises inputting the candidate embedding and one or more sample embeddings into a distance-based classification algorithm.

112. The method of claim 111, wherein the distance-based classification algorithm comprises one or more of: a K-nearest neighbors algorithm, a decision tree algorithm, a random forest algorithm, or a neural network.

113. The method of claim 102, wherein comparing the candidate embedding to one or more sample embeddings comprises utilizing one or more of: a support vector machine (SVM) algorithm, a classification algorithm, or regression algorithm.

114. The method of claim 102, further comprising collecting the sample image.

115. The method of claim 102, where the sample object and the object of interest are plants.

116. A system, comprising:
a processor; and
a memory operably coupled to the processor and storing instructions that, when executed by the processor, cause the system to:
provide a sample image of a sample object to a user;
receive an indication from the user identifying the sample object as a user-created object type;
generate a sample embedding describing the sample object by analyzing the sample image with a pre-trained machine learning model;
associate the indication and the sample embedding with the sample object;
define a support set of images including the sample image, wherein the support set comprises one or more images of sample objects across a dynamic set of one or more object types including the user-created object type;
receive a candidate image of an object of interest;
generate a candidate embedding describing the object of interest by analyzing the candidate image with the pre-trained machine learning model;
identify the object of interest based at least in part by comparing the candidate embedding to one or more sample embeddings associated with the one or more sample objects in the images of the support set.

117. The system of claim 116, wherein the pre-trained machine learning model is not re-trained between generating the sample embedding and generating the candidate embedding.

118. The system of claim 116, wherein the sample embedding comprises one or more predicted properties of the sample object, and wherein the candidate embedding comprises one or more predicted properties of the object of interest.

119. The system of claim 118, wherein the one or more predicted properties of the candidate embedding comprises a first object score representing likelihood that the object of interest is a first object type.

120. The system of claim 118, wherein the one or more predicted properties of the candidate embedding further comprises a second object score representing likelihood that the object of interest is a second object type.

121. The system of claim 116, further comprising a laser and a control system configured to direct the laser at the object of interest.

122. The system of claim 116, wherein comparing the candidate embedding to one or more sample embeddings comprises inputting the candidate embedding and one or more sample embeddings into a distance-based classification algorithm.

123. The system of claim 116, further comprising a camera configured to collect the sample image.

124. The system of claim 116, further comprising a display configured to display the sample image.
